(19) United States
(12) Patent Application Publication
(10) Pub. No.: US 2011/0038573 A1
(43) Pub. Date: Feb. 17, 2011

(54) Easy Open Package with Discrete Strip and Die-Cut Web

(75) Inventor: Andrew W. Moehlenbrock, Simpsonville, SC (US)

Correspondence Address: LAW DEPARTMENT;SEALED AIR CORPORATION, P.O. BOX 464, DUNCAN, SC, 29334, US

(73) Assignee: CRYOVAC, INC., Duncan, SC (US)

(21) Appl. No.: 12/851,815

(22) Filed: Aug. 6, 2010

Related U.S. Application Data
(60) Provisional application No. 61/274,287, filed on Aug. 14, 2009.

(51) Int. Cl. B65D 33/20; B31B 1/90

(52) U.S. Cl. 383/211; 493/214

(57) ABSTRACT

An easy-open package includes a pouch including a first and second side panel joined together along their first and second side edges; a first end; a second end; the panels joined together along their respective second ends; a discrete strip between the panels including a first and second surface each including a sealant, one of the surfaces including an easy-open sealant, the first surface of the strip sealed to the inner surface of the first side panel, the second surface of the strip sealed to the inner surface of the second side panel, the strip near and spaced apart from the first end of the pouch, and spaced apart from the second end of the pouch; a die cut disposed in the first side panel; the first end of the first side panel joined to the second side panel; and a product in the pouch.

This application claims the benefit of U.S. Provisional Application No. 61/274,287, filed Aug. 14, 2009, that application incorporated herein by reference in its entirety.

### FIELD OF THE INVENTION

This invention relates to an easy-open package with a discrete strip and die-cut web, and to methods of making the package.

### BACKGROUND OF THE INVENTION

Food and non-food products, including produce, snack foods, cheese, meat, and the like have long been packaged in containers such as pouches, bags, or lidded trays or formed webs made from various thermoplastic materials such as polyethylene, polypropylene, or polyester (PET). These containers can be formed from a web or webs of thermoplastic material on packaging equipment, using various packaging processes, at a processing/packaging facility. Such equipment and processes includes horizontal form/fill/seal (HFFS), vertical form/fill/seal (VFFS), thermoforming/lidstock, and continuous horizontal packaging (sometimes referred to as Flow-wrap). In each case, the product is manually or automatically placed in a pouch, bag, formed web, tray, etc., the filled container is optionally vacuumized or gas flushed, and the mouth of the container is hermetically or non-hermetically sealed to close and finish the package.

Opening of the finished package (i.e. opening with the use of tools such as scissors or knives) can provide access to the product by the consumer.

Common in the industry is the use of plastic zipper closures; press-to-close or slide zippers; interlocking closures; reclosable fasteners with interlockable fastener elements; interlocking rib and groove elements having male and female profiles; interlocking alternating hook-shaped closure members, and the like. These terms appear in the patent literature, and to some extent may overlap in meaning. These features in some cases may provide an easy-open feature to the package. However, such features are not always easy to open.

There is need in the marketplace for a package, and methods of packaging that can be used in a manner that requires little or no modification to the packager's packaging equipment, while providing a manually (i.e. by hand, without the need for tools such as scissors or knives) openable feature, optionally while maintaining hermeticity of the package when made, and without the use of plastic zipper closures; press-to-close or slide zippers; interlocking closures; reclosable fasteners with interlockable fastener elements; interlocking rib and groove elements having male and female profiles; interlocking alternating hook-shaped closure members, and the like.

Some retail packages currently do not offer an easy-open feature. Examples are some produce bags and snack food bags. In the produce market, there is a need for a cost-effective way to manually open retail produce bags, e.g. a package made in HFFS, VFFS, thermoforming/lidstock, or continuous horizontal packaging processes.

The present invention relates to a package, and methods of making the package, which package is manually openable, and adapted to package non-food products, as well as food products such as e.g. produce, snack foods, cheese, meat, luncheon meat, sausage, culinary nuts, trail mix, etc. The package optionally maintains a hermetic seal until the package is opened.

### SUMMARY OF THE INVENTION

### Statement of Invention/Embodiments of the Invention

In a first aspect, an easy-open package comprises:

a pouch comprising
a first and second side panel each comprising an outer and inner surface, a first and second side edge, and a first and second end, the first and second side panels joined together along their respective first and second side edges;
a first end defined by the first end of at least one of the first and second side panels;
a second end defined by the second ends of the first and second side panels respectively; the first and second side panels joined together along their respective second ends;
a discrete strip, disposed between the first and second side panels, comprising a first and second surface, wherein
   the first and second surface each comprises a sealant,
   at least one of the first and second surfaces of the discrete strip comprises an easy-open sealant,
   the first surface of the discrete strip is sealed to the inner surface of the first side panel,
   the second surface of the discrete strip is sealed to the inner surface of the second side panel,
   the discrete strip is near and spaced apart from the first end of the pouch, and spaced apart from the second end of the pouch;
a die cut disposed in the first side panel;
the first end of the first side panel joined to the second side panel; and
   a product disposed in the pouch.

Optionally, according to various embodiments of the first aspect of the invention:
the second surface of the discrete strip comprises an easy-open sealant.
the first and second side panels are joined together along their respective first and second side edges with a seal.
the first and second side panels are joined together along their respective first and second side edges with a fold.
the first end of the first side panel, and the second side panel, are joined together with a seal.
the first end of the first side panel, and the first end of the second side panel, are joined together with a seal.
the first end of the first side panel, and the first end of the second side panel, are joined together with a fold.
the second end of the first side panel, and the second end of the second side panel, are joined together with a seal.
the second end of the first side panel, and the second end of the second side panel, are joined together with a fold.
the discrete strip is disposed perpendicular to the first and second side edges of the first and second side panel respectively.
the package is absent any zipper.
the package is absent pressure sensitive adhesive.
the package can be opened with a peel force of from 25 grams/inch to 5 pounds/inch.

In a second aspect, an easy-open package comprises:

a pouch comprising
a folded web having an interior surface;
a first transverse seal at a first end of the folded web;
a second transverse seal at a second end of the folded web;
a longitudinal seal extending along the length of the folded web,
a discrete strip positioned adjacent to and spaced apart from the longitudinal seal, the discrete strip comprising a first and second surface each comprising a sealant, at least one of the first and second surfaces of the discrete strip comprising an easy-open sealant;
the first surface of the discrete strip sealed to the interior surface of the folded web, and the second surface of the discrete strip sealed to the interior surface of the folded web;
a die cut disposed in the folded web; and
   a product disposed in the pouch.

Optionally, according to various embodiments of the second aspect of the invention:
the second surface of the discrete strip comprises an easy-open sealant.
the package is absent any zipper.
the package is absent pressure sensitive adhesive.
the package can be opened with a peel force of from 25 grams/inch to 5 pounds/inch.

In a third aspect, a method of making an easy-open package in a horizontal form/fill/seal process comprises:
providing a lay-flat web comprising a die cut;
providing a discrete strip comprising a first and second surface each comprising a sealant, at least one of the first and second surfaces of the discrete strip comprising an easy-open sealant;
advancing the lay-flat web to a forming device to convert the lay-flat web to a folded web having an interior surface;
advancing the discrete strip such that when the package is made, the discrete strip is disposed between a first and second side panel of the package;
making side seals in the folded web to produce an open pouch comprising
   the first and second side panel each comprising an outer and inner surface, first and second side edges, and a first and second end, the first and second side panels joined together along their respective first and second side edges by a seal,
   a first end defined by the first end of at least one of the first and second side panels,
   a second end defined by the second ends of the first and second side panels respectively,
   the first and second side panels joined together along their respective second ends,
   the discrete strip spaced apart from the first end and the second end of the pouch, and
   the die cut disposed in the first side panel,
putting a product in the open pouch; and
sealing the first end of the first side panel to the second side panel;
at any time during the method of making the easy-open package, sealing the first surface of the discrete strip to the lay-flat web or folded web such that the first surface of the discrete strip is sealed to the inner surface of the first side panel, and
sealing the second surface of the discrete strip to the lay-flat web or folded web such that the second surface of the discrete strip is sealed to the to the inner surface of the second side panel; and
during or after the step of making side seals in the folded web, cutting the web.

Optionally, according to various embodiments of the third aspect of the invention:
the second surface of the discrete strip comprises an easy-open sealant.
the first end of the first side panel, and the first end of the second side panel, are joined together with a seal.
the first end of the first side panel, and the first end of the second side panel, are joined together with a fold.
the second end of the first side panel, and the second end of the second side panel, are joined together by a seal.
the second end of the first side panel, and the second end of the second side panel, are joined together by a fold.
the discrete strip is disposed perpendicular to the first and second side edges of the first and second side panel respectively.
the package is absent any zipper.
the package is absent pressure sensitive adhesive.
the package can be opened with a peel force of from 25 grams/inch to 5 pounds/inch.

In a fourth aspect, a method of making an easy-open package in a horizontal form/fill/seal process comprises:
providing a lay-flat web comprising a die cut;
providing a discrete strip comprising a first and second surface each comprising a sealant, at least one of the first and second surfaces of the discrete strip comprising an easy-open sealant, one of the first or second surfaces of the discrete strip anchored to the lay-flat web;
advancing the lay-flat web with the discrete strip anchored thereto to a forming device
to convert the lay-flat web to a folded web having an interior surface;
making side seals in the folded web to produce an open pouch comprising
   the first and second side panels each comprising an outer and inner surface, first and second side edges, and a first and second end, the first and second side panels joined together along their respective first and second side edges by a seal,
   a first end defined by the first end of at least one of the first and second side panels,
   a second end defined by the second ends of the first and second side panels respectively,
   the first and second side panels joined together along their respective second ends,
the discrete strip disposed between the first and second side panels, and spaced apart from the first end and the second end of the pouch, the first surface of the discrete strip sealed to the inner surface of the first side panel, and
   the die cut disposed in the first side panel,
putting a product in the open pouch;
sealing the first end of the first side panel to the second side panel;
at any time during the method of making the easy-open package, sealing the first surface of the discrete strip to the lay-flat web or folded web such that the first surface of the discrete strip is sealed to the inner surface of the first side panel, and sealing the second surface of the discrete strip to the lay-flat web or folded web such that the second surface of the discrete strip is sealed to the inner surface of the second side panel; and
during or after the step of making side seals in the folded web, cutting the web.

Optionally, according to various embodiments of the fourth aspect of the invention:
the second surface of the discrete strip comprises an easy-open sealant.
the first end of the first side panel, and the first end of the second side panel, are joined together with a seal.
the first end of the first side panel, and the first end of the second side panel, are joined together with a fold.
the second end of the first side panel, and the second end of the second side panel, are joined together by a seal.
the second end of the first side panel, and the second end of the second side panel, are joined together by a fold.
the discrete strip is disposed perpendicular to the first and second side edges of the first and second side panel respectively.
the package is absent any zipper.
the package is absent pressure sensitive adhesive.
the package can be opened with a peel force of from 25 grams/inch to 5 pounds/inch.

In a fifth aspect, a method of making an easy-open package in a vertical form/fill/seal process comprises:
providing a lay-flat web comprising a die cut;
providing a discrete strip comprising a first and second surface each comprising a sealant, at least one of the first and second surfaces of the discrete strip comprising an easy-open sealant;
advancing the lay-flat web over a forming device to convert the lay-flat web to a folded web having an interior surface;
advancing the discrete strip such that when the package is made, the discrete strip is disposed between a first and second side panel of the package; making a longitudinal seal in the folded web;
transversely sealing the folded web to produce a first transverse seal to define a first pouch, wherein the first transverse seal is a bottom transverse seal of the first pouch; putting a product in the first pouch;
advancing the folded web, with the first pouch, downward a predetermined distance;
transversely sealing the first pouch to produce a top transverse seal in the first pouch, and a bottom transverse seal in a second pouch, the second pouch disposed above the first pouch; and
transversely cutting the folded web to separate the first pouch from the second pouch to make a package, the package comprising
   the first and second side panels each comprising an outer and inner surface, first and second side edges, and a first and second end, the first and second side panels joined together along their respective first and second side edges, a first end defined by the first ends of the first and second side panels respectively,
   a second end defined by the second ends of the first and second side panels respectively,
   the discrete strip disposed between the first and second side panels, the first surface of the discrete strip sealed to the inner surface of the first side panel,
   the second surface of the discrete strip sealed to the inner surface of the second side panel, and the discrete strip near and spaced apart from the first end of the pouch, and spaced apart from the second end of the pouch; and
   the die cut in the first side panel;
wherein
at any time during the method of making the easy-open package, sealing the first surface of the discrete strip to the lay-flat web or the folded web, such that the first surface of the discrete strip is sealed to the inner surface of the first side panel, and sealing the second surface of the discrete strip to the inner surface of the second side panel.

Optionally, according to various embodiments of the fifth aspect of the invention:
the second surface of the discrete strip comprises an easy-open sealant.
the first and second side panels are joined together along their respective first and second side edges with a seal.
the first and second side panels are joined together along their respective first and second side edges with a fold.
the first end of the first side panel, and the first end of the second side panel, are joined together with a seal.
the first end of the first side panel, and the first end of the second side panel, are joined together with a fold.
the second end of the first side panel, and the second end of the second side panel, are joined together with a seal.
the second end of the first side panel, and the second end of the second side panel, are joined together with a fold.
the package is absent any zipper.
the package is absent pressure sensitive adhesive.
the package can be opened with a peel force of from 25 grams/inch to 5 pounds/inch.

In a sixth aspect, a method of making an easy-open package in a vertical form/fill/seal process comprises:
providing a lay-flat web comprising a die cut;
providing a discrete strip comprising a first and second surface each comprising a sealant, at least one of the first and second surfaces of the discrete strip comprising an easy-open sealant, one of the first or second surfaces of the discrete strip anchored to the lay-flat web;
advancing the lay-flat web with the discrete strip anchored thereto over a forming device to convert the lay-flat web to a folded web having an interior surface; making a longitudinal seal in the folded web;
transversely sealing the folded web to produce a first transverse seal to define a first pouch, wherein the first transverse seal is a bottom transverse seal of the first pouch;
putting a product in the first pouch;
advancing the folded web, with the first pouch, downward a predetermined distance;
transversely sealing the first pouch to produce a top transverse seal in the first pouch, and a bottom transverse seal in a second pouch, the second pouch disposed above the first pouch; and
transversely cutting the folded web to separate the first pouch from the second pouch to make a package, the package comprising
   a first and second side panel each comprising an outer and inner surface, first and second side edges, and a first and second end, the first and second side panels joined together along their respective first and second side edges,
   a first end defined by the first ends of the first and second side panels respectively,
   a second end defined by the second ends of the first and second side panels respectively,
   the discrete strip disposed between the first and second side panels, the first surface of the discrete strip sealed to the inner surface of the first side panel, the second surface of the discrete strip sealed to the inner surface of the second side panel, and the discrete strip near and spaced apart from the first end of the pouch, and spaced apart from the second end of the pouch; and
   the die cut in the first panel;
wherein
   at any time during the method of making the easy-open package, sealing the first surface of the discrete strip to the lay-flat web or folded web such that the first surface of the discrete strip is sealed to the inner surface of the first side panel, and sealing the second surface of the discrete strip to the lay-flat web or folded web such that the second surface of the discrete strip is sealed to the inner surface of the second side panel.

Optionally, according to various embodiments of the sixth aspect of the invention:
the second surface of the discrete strip comprises an easy-open sealant.
the first and second side panels are joined together along their respective first and second side edges with a seal.
the first and second side panels are joined together along their respective first and second side edges with a fold.
the first end of the first side panel, and the first end of the second side panel, are joined together with a seal.
the first end of the first side panel, and the first end of the second side panel, are joined together with a fold.
the second end of the first side panel, and the second end of the second side panel, are joined together with a seal.
the second end of the first side panel, and the second end of the second side panel, are joined together with a fold.
the package is absent any zipper.
the package is absent pressure sensitive adhesive.
the package can be opened with a peel force of from 25 grams/inch to 5 pounds/inch.

In a seventh aspect, a method of making an easy-open package having a formed web comprises:
providing a formed web comprising a product cavity;
providing a product;
providing a lidstock, having a first and second surface, comprising
   a lay-flat web, and
   a die cut;
providing a discrete strip comprising a first and second surface each comprising a sealant, at least one of the first and second surfaces of the discrete strip comprising an easy-open sealant;
placing the product in the product cavity;
sealing the first surface of the lidstock to the formed web, such that the discrete strip
is disposed between the lidstock and the formed web;
sealing the first surface of the discrete strip to the first surface of the lidstock;
sealing the second surface of the discrete strip to the formed web; and
cutting the lidstock and formed web to make the package.

Optionally, according to various embodiments of the seventh aspect of the invention:
the second surface of the discrete strip comprises an easy-open sealant.
the package is absent any zipper.
the package is absent pressure sensitive adhesive.
the package can be opened with a peel force of from 25 grams/inch to 5 pounds/inch.

In an eighth aspect, a method of making an easy-open package having a formed web comprises:
providing a formed web comprising a product cavity;
providing a product;
providing a lidstock, having a first and second surface, comprising
   a lay-flat web, and
   a die cut;
providing a discrete strip comprising a first and second surface each comprising a sealant, at least one of the first and second surfaces of the discrete strip comprising an easy-open sealant, one of the first or surfaces of the discrete strip anchored to the first surface of the lidstock;
placing the product in the product cavity;
sealing the lidstock to the formed web, such that the discrete strip is disposed between the lidstock and the formed web;
sealing the first surface of the discrete strip to the first surface of the lidstock;
sealing the second surface of the discrete strip to the formed web; and
cutting the lidstock and formed web to make the package.

Optionally, according to various embodiments of the eighth aspect of the invention:
the second surface of the discrete strip comprises an easy-open sealant.
the package is absent any zipper.
the package is absent pressure sensitive adhesive.
the package can be opened with a peel force of from 25 grams/inch to 5 pounds/inch.

In a ninth aspect, a method of making an easy-open package in a continuous horizontal packaging process comprises:
providing a lay-flat web, the lay-flat web comprising a die cut;
providing a discrete strip comprising a first and second surface each comprising a sealant, at least one of the first and second surfaces comprising an easy-open sealant;
advancing the lay-flat web to a forming device to convert the lay-flat web into a folded web having an interior surface;
advancing the discrete strip such that when the package is made, the discrete strip is disposed between a first and second side panel of the package;
advancing a product to the forming device such that the folded web envelopes the product;
longitudinally sealing the folded web to make a longitudinal seal;
transversely sealing the folded web, with the product therein, to produce a leading transverse seal to define a first pouch;
advancing the folded web, with the leading transverse seal, forward a predetermined distance;
transversely sealing the first pouch to produce a trailing transverse seal in the first pouch, and a leading transverse seal in a second pouch, the second pouch disposed upstream of the first pouch; and
cutting the folded web to separate the first pouch from the second pouch to form an individual package comprising the first and second side panel;
at any time during the method of making the easy-open package, sealing the first surface of the discrete strip to the lay-flat web or the folded web, such that the first surface of the discrete strip is sealed to the inner surface of the first side panel, and sealing the second surface of the discrete strip to the lay-flat web or the folded web, such that the second surface of the discrete strip is sealed to the inner surface of the second side panel.

Optionally, according to various embodiments of the ninth aspect of the invention:
the second surface of the discrete strip comprises an easy-open sealant.
the package is absent any zipper.
the package is absent pressure sensitive adhesive.
the package can be opened with a peel force of from 25 grams/inch to 5 pounds/inch.

In a tenth aspect, a method of making an easy-open package in a continuous horizontal packaging process comprises:
providing a lay-flat web, the lay-flat web comprising a die cut;
providing a discrete strip comprising a first and second surface each comprising a sealant, at least one of the first and second surfaces comprising an easy-open sealant, one of the first or second surfaces of the discrete strip anchored to the first surface of the lay-flat web;
advancing the lay-flat web with the discrete strip anchored thereto to a forming device to convert the lay-flat web into a folded web having an interior surface;
advancing a product to the forming device such that the folded web envelopes the product;
longitudinally sealing the folded web to make a longitudinal seal;
transversely sealing the folded web, with the product therein, to produce a leading transverse seal to define a first pouch;
advancing the folded web, with the leading transverse seal, forward a predetermined distance;
transversely sealing the first pouch to produce a trailing transverse seal in the first pouch, and a leading transverse seal in a second pouch, the second pouch disposed upstream of the first pouch; and
cutting the folded web to separate the first pouch from the second pouch to form an individual package comprising a first and second side panel;
at any time during the method of making the easy-open package, sealing the first surface of the discrete strip to the lay-flat web or the folded web, such that the first surface of the discrete strip is sealed to the inner surface of the first side panel, and sealing the second surface of the discrete strip to the lay-flat web or the folded web, such that the second surface of the discrete strip is sealed to the inner surface of the second side panel.

Optionally, according to various embodiments of the tenth aspect of the invention:
the second surface of the discrete strip comprises an easy-open sealant.
the package is absent any zipper.
the package is absent pressure sensitive adhesive.
the package can be opened with a peel force of from 25 grams/inch to 5 pounds/inch.

In an eleventh aspect, a pouch comprises:
a first and second side panel each comprising an outer and inner surface, a first and second side edge, and a first and second end, the first and second side panels joined together along their respective first and second side edges;
a first end defined by the first end of at least one of the first and second side panels;
a second end defined by the second ends of the first and second side panels respectively;
the first and second side panels joined together along their respective second ends;
a discrete strip, disposed between the first and second side panels, comprising a first and second surface, wherein
   the first and second surface each comprises a sealant,
   at least one of the first and second surfaces of the discrete strip comprises an easy-open sealant.
   the first surface of the discrete strip is sealed to the inner surface of the first side panel,
   the second surface of the discrete strip is sealed to the inner surface of the second side panel,
   the discrete strip is near and spaced apart from the first end of the pouch, and spaced apart from the second end of the pouch;
a die cut disposed in the first side panel; and
the first end of the first side panel joined to the second side panel.

Optionally, according to various embodiments of the eleventh aspect of the invention:
the second surface of the discrete strip comprises an easy-open sealant.
the first and second side panels are joined together along their respective first and second side edges with a seal.
the first and second side panels are joined together along their respective first and second side edges with a fold.
the second end of the first side panel, and the second end of the second side panel, are joined together with a seal.
the second end of the first side panel, and the second end of the second side panel, are joined together with a fold.
the pouch, and a package made from the pouch, is absent any zipper.
the pouch, and a package made from the pouch, is absent pressure sensitive adhesive.
the discrete strip is disposed perpendicular to the first and second side edges of the first and second side panel respectively.
when the pouch is sealed to make a package, the package can be opened with a peel force of from 25 grams/inch to 5 pounds/inch.

In a twelfth aspect, a method of making a bag with a die cut and a discrete strip disposed thereon comprises:
extruding a thermoplastic tube to make a bag tubing;
providing a discrete strip comprising a first and second surface each comprising a sealant, at least one of the first and second surfaces comprising an easy-open sealant:
slitting the tubing at a longitudinal edge thereof to make a slit bag tubing; placing the discrete strip inside the slit bag tubing; and
transversely cutting and sealing the slit bag tubing at predetermined intervals to make a plurality of individual bags, each bag having a die cut disposed thereon, each bag comprising
   a first and second side panel each comprising an outer and inner surface, a first and second side edge, and a first and second end, the first and second side panels joined together along at least a portion of their respective first and second side edges by a seal,
   a first end defined by the first end of at least one of the first and second side panels,
   an end fold defined by the second ends of the first and second side panels respectively,
   the discrete strip disposed between the first and second side panels, and spaced apart from the first end and the end fold of the bag,
   the first surface of the discrete strip sealed to the inner surface of the first side panel, and
   the second surface of the discrete strip sealed to the inner surface of the second side panel,
wherein at any time before transversely cutting the bag tubing to produce a bag, the bag tubing or slit bag tubing is die cut at predetermined intervals to make a plurality of die cuts in the bag tubing or slit bag tubing respectively; and
at any time during the method of making the bag, the discrete strip is sealed to the slit bag tubing, or the inner surfaces of the first and second side panels respectively.

Optionally, according to various embodiments of the twelfth aspect of the invention:
the second surface of the discrete strip comprises an easy-open sealant.
the bag, and a package made from the bag, is absent any zipper.
the bag and a package made from the bag, is absent pressure sensitive adhesive.
the package can be opened with a peel force of from 25 grams/inch to 5 pounds/inch.

### BRIEF DESCRIPTION OF THE DRAWINGS

The present invention is illustrated by reference to the following drawing figures, encompassing different views of various embodiments of the invention, wherein:

FIG. 1 is an elevational view of a package;

FIG. 2 is an enlarged view of the package of FIG. 1;

FIG. 2A is an enlarged cross-sectional view of a portion of FIG. 1;

FIG. 3 is a front view of the package of FIG. 1, viewed along lines 3-3 of FIG. 1;

FIG. 4 is a back view of the package of FIG. 1, viewed along lines 4-4 of FIG. 1;

FIG. 5 an enlarged view of a portion of the package of FIG. 1 according to another embodiment;

FIG. 6 is a cross-sectional view of a discrete strip;

FIG. 7 is a cross-sectional view of a discrete strip according to another embodiment;

FIG. 8A is a perspective view of a HFFS process and apparatus for making a package;

FIG. 8B is a perspective view of a HFFS process and apparatus for making a package according to another embodiment;

FIG. 9A is a perspective view of a HFFS process and apparatus for making a package according to another embodiment;

FIG. 9B is a perspective view of a HFFS process and apparatus for making a package according to another embodiment;

FIG. 9C is a perspective view of a section of folded web;

FIG. 9D is a perspective view of a section of gusseted folded web;

FIG. 10 is an elevational view of a VFFS process and apparatus for making a package;

FIG. 11 an elevational view of a VFFS process and apparatus for making a package according to another embodiment;

FIG. 12 is a perspective view of a roll of lay-flat film and a discrete strip;

FIG. 13 is a perspective view of a roll of lay-flat film and a discrete strip according to another embodiment;

FIG. 14 is a perspective of a roll of lay-flat film and a discrete strip according to yet another embodiment;

FIG. 15 is a front view of an alternative embodiment of the package;

FIG. 16 is a back view of the package of FIG. 15;

FIG. 17 is an elevational view of two consecutive pouches in a VFFS embodiment;

FIG. 18 is a front view of another alternative embodiment of the package;

FIG. 19 is a front view of another alternative embodiment of the package;

FIG. 20 is a perspective view of a folded web for use in the invention;

FIG. 21A is a perspective view of a folded web for use in the invention;

FIG. 21B is a perspective view of a folded web for use in the invention;

FIG. 22 is a side view of a tray for use in connection with the invention.

FIG. 23A is a perspective view of a package;

FIG. 23B is a perspective view of the package of FIG. 23A in an opened condition;

FIG. 24 is a plan view of a lidstock;

FIG. 25 is a plan view of a lidstock according to another embodiment;

FIG. 26 is an elevational view of a continuous horizontal packaging process and apparatus for making a package;

FIG. 27 a front end view of the apparatus of FIG. 26, viewed along lines 27-27 of FIG. 26;

FIGS. 28A, 28B, and 28C are each cross-sectional views of a portion of the package, showing a sequence for opening the package;

FIGS. 29A, 29B, and 29C are each plan views of the package, showing a sequence for opening the package;

FIG. 29D is an enlarged view of a portion of the package of FIG. 29C;

FIGS. 30A, 30B, 30C, 30D, 30E, and 30F are each a plan view of alternative embodiments;

FIG. 31 is a cross sectional view of an alternative embodiment;

FIG. 32 is a plan view of an alternative embodiment of the invention; and

FIG. 33 is a cross sectional view of FIG. 32.

### DEFINITIONS

“Anchored”, “anchoring” and the like herein refers to sealing two surfaces together, and refers to the resulting bond between surfaces. Sealing is done by means of a sealant. Adhering is done by means of an adhesive.

In processes described herein where a strip is anchored to a web or side panel, either during the process wherein the web and strip are advanced, or when a strip has been preanchored to the web before the start of the process, anchoring can be done by use of any suitable continuous or discontinuous sealing or adhesive material and method. Such anchoring is done to hold the strip to the web during the relevant packaging process.

In some embodiments, wherein the anchor is already relatively strong or continuous, e.g. a heat seal that constitute either a relatively strong heat seal, or an easy-open seal as defined herein, the anchor functions not only to hold the strip to the web during the relevant packaging process, but also as a final seal of that surface of the strip to the web (lay-flat or folded) or panel made from the web.

Any subsequent disclosed or recited step in the process of sealing one of the surfaces (i.e. the anchored surface) of the strip to a web or panel, is already completed by the anchoring step. In these embodiments, then, contact of a seal device, e.g. a seal bar in the region of the anchor, in a subsequent step, may add no further or separate seal to that surface of the strip.

Any subsequent step in the process of sealing the other surface of the strip to a web or panel, then, may add no further or separate seal to the anchored surface of the strip.

In some embodiments where the bond is a relatively weak or discontinuous one, e.g. a discontinuous seal, spots or narrow stripes of adhesive. etc., in a subsequent step of sealing one of the surfaces of the strip to the web or panel, a seal bar that seals one of the surfaces of the strip to the web or panel can contact the web or panel in the region where the anchor is already disposed. The seal in that region may be either enhanced, or initially created, by the subsequent sealing step.

Sealing of the surface of the strip to a web, as a process step disclosed or recited herein, should be understood in this light.

“Close-looped” herein refers to a die cut that defines a closed pattern or path in the first side panel whereby the web material within the path (the die-cut segment) can be removed from the panel.

“Die cut” and the like herein refers to methods of cutting or scoring materials, including rotary die, steel rule die, platen die cutting, and laser cutting or scoring, and/or the resultant cut or score. A die cut can extend entirely or partially through the relevant layer or web, and can leave intact a certain amount of material. The depth of the cut can vary from package to package, and within a single die cut on a given package.

“Die-cut segment” herein refers to a portion of the first side panel that can be displaced or completely removed because of the presence of a closed loop or open loop die cut. The die-cut segment is a piece of the first side panel, and when displaced or removed can function as a tamper evidence device, and facilitates access to the interior of the package.

“Discrete” with respect to the discrete strip is used herein to mean independently made (the strip is not an integral part of the web when the web is made) or constituting a separate entity from the web.

“Easy-open” herein refers to a package that can be manually opened relatively easily. The physical mode of opening may include a) actual peeling at the discrete strip/web interface (adhesive failure), or b) a sealant layer of the discrete strip breaking completely through, and peeling then occurring between the sealant layer and an adjacent layer within the strip (delamination failure), or c) breaking within a sealant layer by rupturing of the sealant material itself (cohesive failure). The peel force required to open the package can be measured by an evaluation of seal strength or peel strength in accordance with the test procedure set out in ASTM F88, incorporated herein by reference in its entirety, using a crosshead speed of 8 to 12 inches/minute and an initial jaw gap of from 1.00 inch to 2.00 inch. Typical peel forces for opening the package of the invention can range from e.g. 25 grams/inch to 3 pounds/inch, e.g. from 100 grams/inch to 2 pounds/inch, such as from 200 grams/inch to 1.5 pounds/inch. In some cases, the sealant may actually peel away from the surface to which it is adhered (adhesive failure), or breakage of the sealant and delamination along an adjacent layer interface may occur (delamination failure) or a rupture of the sealant can occur (cohesive failure). Depending on the design and geometry of the seal, peel forces can in some embodiments be higher than 3 pounds/inch, e.g. 3.5, 4.0, 4.5, or 5 pounds/inch, or values intermediate these values.

“Easy-open seal” herein refers to a seal involving the discrete strip and web in which materials and sealing conditions are chosen for the discrete strip and web such that the package is easy-open with a physical mode of opening of adhesive failure, delamination failure, or cohesive failure as described herein.

“Easy-open sealant” herein refers to a material chosen for one or both surfaces of the discrete strip, such that when such surface is sealed to a web, it provides a package that is easy-open with a physical mode of opening of adhesive failure, delamination failure, or cohesive failure as described herein.

“Ethylene/alpha-olefin copolymer” (EAO) herein refers to copolymers of ethylene with one or more comonomers selected from C₃ to C₁₀ alpha-olefins such as propene, butene-1, hexene-1, octene-1, etc. EAO includes heterogeneous materials such as linear medium density polyethylene (LMDPE), linear low density polyethylene (LLDPE), and very low and ultra low density polyethylene (VLDPE and ULDPE); single-site catalyzed materials such as homogeneous linear ethylene/alpha olefin copolymers and long chain branched ethylene/alpha olefin copolymers; and multicomponent ethylene/alpha-olefin interpenetrating network resin (or “IPN resin”).

“Ethylene homopolymer or copolymer” herein refers to polyethylene (PE) such as ethylene homopolymer such as low density polyethylene (LDPE), medium density polyethylene (MDPE), high density polyethylene (HDPE); ethylene/alpha olefin copolymer such as those defined herein; ethylene/vinyl acetate copolymer (EVA); ethylene/alkyl acrylate copolymer such as ethylene/methyl acrylate copolymer (EMA) or ethylene/ethyl acrylate copolymer (EEA), or ethylene/butyl acrylate copolymer (EBA); ethylene/(meth)acrylic acid copolymer; or ionomer resin (IO).

“Fig.” herein refers to drawing figure; “Figs.” to drawing figures.

“Film” is used herein to mean a thermoplastic film, laminate, or web, either multilayer or monolayer, that may be used in connection with the present invention. Film can be of any suitable thickness, e.g. between 0.1 and 30 mils.

“Fin seal” is used herein to mean, in the case of a single web, folding one edge of a web towards the opposite edge of the web, and sealing the facing inner surfaces together. In the case of two webs, a fin seal is a seal formed by sealing the inner surface of the edge of one web to the inner surface of a corresponding edge of another web.

“Lap seal” is used herein to mean a seal made by sealing an inside surface of a web to an outside surface of a web. The inside and outside surfaces can both be on a single web; or the inside surface can be of one web, and the outside surface of a second web.

“Lidstock” herein refers to a film used to cover a container or tray that carries a product, and can be sealed to the tray, typically as a perimeter heat seal. Lidstock typically is supplied to a food processor in a lay flat film rolled onto a roll.

“Longitudinal seal” herein refers to a fin seal or lap seal.

“Olefinic” and the like herein refers to a polymer or copolymer derived at least in part from an olefinic monomer.

“Oxygen barrier” and the like herein refers to materials having an oxygen permeability, of the barrier material, less than 500 cm³ O₂/m²·day·atmosphere (tested at 1 mil thick and at 25° C., 0% RH according to ASTM D3985), such as less than 100, less than 50, less than 25, less than 10, less than 5, and less than 1 cm³ O₂/m²·day·atmosphere. Examples of polymeric materials useful as oxygen barrier materials are ethylene/vinyl alcohol copolymer (EVOH), polyvinylidene dichloride (PVDC), vinylidene chloride/methyl acrylate copolymer, vinylidene chloride/vinyl chloride copolymer, polyamide (nylon), and polyester (PET).

“Polymer” and the like herein means a homopolymer, but also a copolymer thereof, including terpolymer, tetrapolymer, block copolymer, etc.

“Pouch” herein means a pouch or bag.

“Pressure sensitive adhesive” (PSA) herein refers to a repositionable adhesive that bonds firmly with the application of light pressure. It adheres to most surfaces with very slight pressure; is available in solvent and latex or water based forms, and is often based on non-crosslinked rubber adhesives, acrylics, or polyurethanes. PSA forms viscoelastic bonds that are aggressively and permanently tacky; adhere without the need for more than hand pressure; and require no activation by water, solvent, or heat. Some PSA materials are cured by hot air, electron beam, UV, or chemical (peroxide) means. They are available in a wide variety of chemical compositions and systems including acrylic and methacrylate adhesives, emulsion-based acrylic adhesive; rubber-based pressure sensitive adhesive, styrene copolymers (styrene/isoprene/styrene and styrene/butadiene/styrene block copolymers), and silicones. For purposes of this definition, “PSA” includes hot melt adhesives. A hot melt adhesive is a thermoplastic adhesive compound, usually solid at room temperature which becomes fluid on heating for use.

“Registration device” herein refers to any mark, pattern, die cut or feature of a web or strip, that facilitates the advancement of the web or discrete strip, in a controlled manner, into a packaging machine, where the web or discrete strip is used to make individual packages. The device can be e.g. printed or placed in uniformly spaced fashion along or near an edge of the web or discrete strip, i.e. registration marks, or in an area near the middle of a web that does not interfere with decorative printed graphics. These marks are used in connection with appropriate sensors to controllably advance the web or strip. Where die cuts are used as a registration device, detected by sensors, it may not be necessary to print registration marks on the web or discrete strip.

“Seal” herein means a bond between two thermoplastic surfaces, e.g. as produced by heat sealing, radio frequency (RF) sealing, ultrasonic sealing, or permanent adhesive.

“Sealant” is a polymeric material or blend of materials, such as olefinic polymer or copolymer such as an ethylenic polymer or copolymer, that can form a surface of the discrete strip of the invention, or a web to which the discrete strip is sealed, and form a bond between two thermoplastic surfaces. A permanent adhesive can also be a sealant. “Sealant” herein, with respect to the discrete strip, or a web to which the discrete strip is adhered, excludes a repositionable adhesive or PSA.

“Strip” herein refers to an elongate piece of thermoplastic material, typically longer in a first direction than in a direction perpendicular to the first direction, e.g. rectangular; but can also be square, round, oblong, elliptical, or any appropriate shape in plan view. The strip can be of any suitable thickness, e.g. between 0.1 and 30 mils.

“Tamper evidence”, “tampering”, and the like herein refers to visual evidence of a breach in a package; i.e. that someone has accidentally or intentionally opened or partially opened the package, or attempted to do so.

“Thermoplastic” herein includes plastic materials that when heated to a softening or melting point may be reshaped without significant thermal degradation (burning). Thermoplastic includes both materials that are not crosslinked, or that are crosslinked by chemical or radiation means.

“Tray” herein refers to a formed member that has a tray bottom, tray sides, and a tray flange around the upper perimeter of the tray, where the tray bottom and tray sides form an internal cavity within which a product can be placed. The cavity can be enclosed by a lidstock sealed to the tray flange.

“Web” is used herein to mean a thermoplastic film, laminate, or web, either multilayer or monolayer, that may be used in connection with the present invention. The web can be of any suitable thickness, e.g. between 0.1 and 30 mils, and the web can be of any suitable length and width.

“Zipper” and the like herein refers to a plastic zipper closure; press-to-close or slide zipper; interlocking closure; reclosable fastener with interlockable fastener elements; interlocking rib and groove elements having male and female profiles; interlocking alternating hook-shaped closure, and the like.

All compositional percentages used herein are presented on a “by weight” basis, unless designated otherwise.

Drawings herein are not necessarily to scale, and certain features of the invention may be graphically exaggerated for clarity.

### DETAILED DESCRIPTION OF THE INVENTION

1. Package

Referring to the drawings, a package 5 according to the invention is shown. Package 5 includes a pouch 7 that can be made from either a single web, or two webs, to form a first or front side panel 12, and a second or back side panel 14.

A. Web(s)

In either embodiment, the web or webs comprises a thermoplastic material of any suitable composition, including those having as at least one component olefinic materials such as ethylene or propylene polymers or copolymers, e.g. polyethylene or ethylene/alpha olefin copolymers; polyethylene terephthalate (PET); and including webs typically used in, or useful in, HFFS, VFFS, lidstock/tray, continuous horizontal packaging and side-seal bag making apparatus and processes. The web or webs can be monolayer or multilayer in construction, can be coextruded, laminated, or made by any suitable film making process, and can have any suitable thickness.

Examples of web(s) useful in the invention include H7225B™, a barrier hybrid material used for products requiring a high oxygen barrier, such as shredded cheese; H7525B™ a barrier hybrid material used for products requiring a high oxygen barrier, such as bacon and smoked and processed meat; CPO4140™, a low barrier (high OTR) material used in produce packaging, CPM4090, a microwaveable packaging film for fresh cut produce; and T7225B™, a barrier material used as lidstock for products requiring a high oxygen barrier, such as luncheon meat. These are all commercial products produced by the Cryovac business unit of Sealed Air Corporation.

H7225B™ is a laminate having the construction PET//adhesive//coextruded barrier film, where the PET is a biaxially oriented polyester film, and the barrier film has in one embodiment the construction LDPE (low density polyethylene)/EVA tie/nylon/EVOH+nylon/nylon/EVA tie/EAO. The overall thickness of the laminate can be any of several gauges, being typically about 2.5 mils. The LDPE is the surface of the barrier film adhered, by the adhesive, to the PET film. The EAO typically acts as the heat sealant layer of the film, and finished laminate, and in packaging made from the laminate, the EAO will form the inner or sealant surface of the package, facing the contained product, and the PET will form the outer or skin surface of the package. H7225B™ can be used as a lidstock (non-forming) web.

H7525B™ is a laminate having the construction PET//adhesive//coextruded barrier film, where the PET is a biaxially oriented polyester film, and the barrier film has in one embodiment the construction LDPE (low density polyethylene)/EVA/LLDPE tie/EVOH/LLDPE tie/EVA/EAO. The overall thickness of the laminate can be any of several gauges, being typically about 2.5 mils. The LDPE is the surface of the barrier film adhered, by the adhesive, to the PET film. The EAO typically acts as the heat sealant layer of the film, and finished laminate, and in packaging made from the laminate, the EAO will form the inner or sealant surface of the package, facing the contained product, and the PET will form the outer or skin surface of the package. H7525B™ can be used as a lidstock (non-forming) web.

CPO4140™ is a laminate having the construction BOPP//adhesive/monolayer LLDPE film. A typical gauge for the laminate is about 1.8 mils. The LLDPE typically acts as the heat sealant layer of the finished laminate, and in packaging made from the laminate, the LLDPE will form the inner or sealant surface of the package, facing the contained product, and the BOPP will form the outer or skin surface of the package.

CPM4090™ is a laminate having the construction BOPP//adhesive/monolayer LLDPE+LDPE film. A typical gauge for the laminate is about 2 mils. The LLDPE+LDPE layer typically acts as the heat sealant layer of the finished laminate, and in packaging made from the laminate, the LLDPE+LDPE will form the inner or sealant surface of the package, facing the contained product, and the BOPP will form the outer or skin surface of the package.

T7225B™ film has the construction EAO/EAO/LLDPE tie/nylon/EVOH/nylon/EVA tie/EVA tie/nylon. The first layer of EAO typically acts as the heat sealant layer of the film, and in packaging made from the laminate, the EAO will form the inner or sealant surface of the package, facing the contained product, and the nylon of the last layer will form the outer or skin surface of the package. T7225B™ is used as a lidstock (non-forming) web.

Referring to the drawings, the first side panel 12 has a top portion 9, a first side edge 31, a second side edge 33, and a lower portion 17. The second side panel 14 has a top portion 11, a first side edge 35, a second side edge 37, and a lower portion 18. The first and second side panels 12 and 14 are joined together along their respective first and second side edges by either a seal or a fold. As shown, first side edge 31 of first side panel 12 is joined to first side edge 35 of second side panel 14 by a seal 30. Second side edge 33 of first side panel 12 is joined to second side edge 37 of second side panel 14 by a heat seal 32. The second end 34 of the pouch 7 can be either a seal or a fold. Where a single web is used to make the pouch, second end 34 will typically be a fold, although even after the web is folded, a seal such as a heat seal can optionally be installed in the area of the fold. Where two webs of film are used to make panels 12 and 14, second end 34 will be a seal that joins panels 12 and 14 together along their respective lower portions 17 and 18. The two webs can be from the same material, or can be different in composition, structure, etc.

B. Discrete Strip

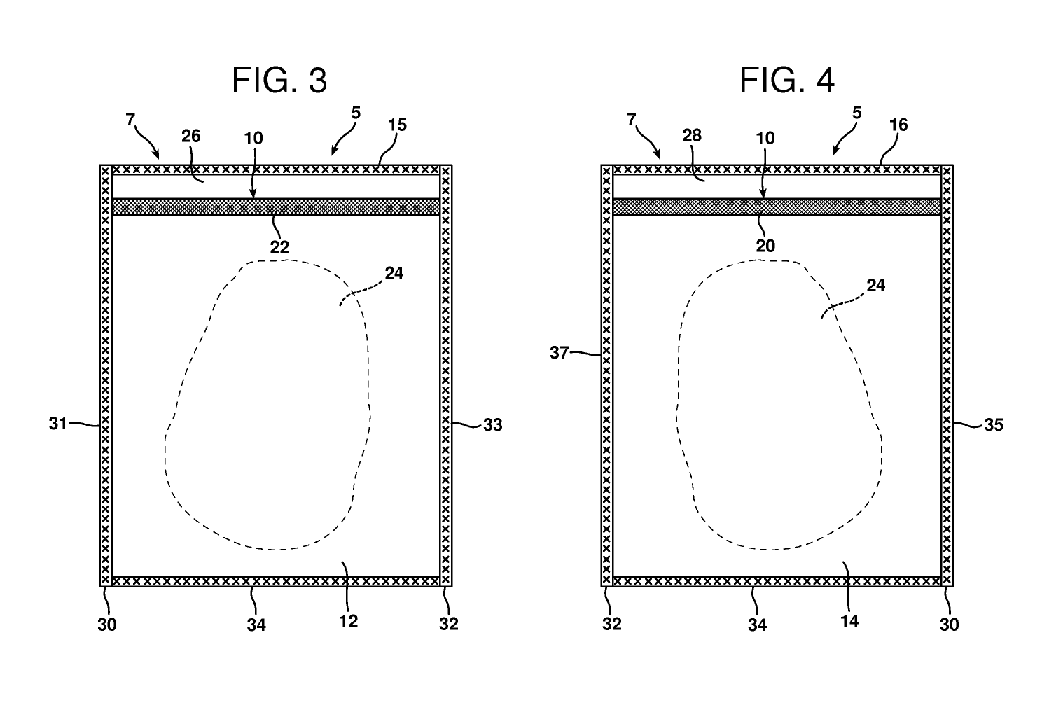

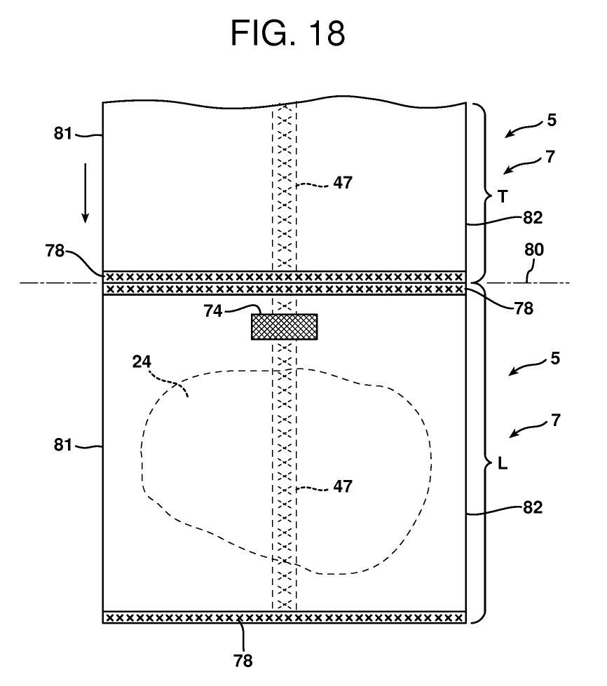

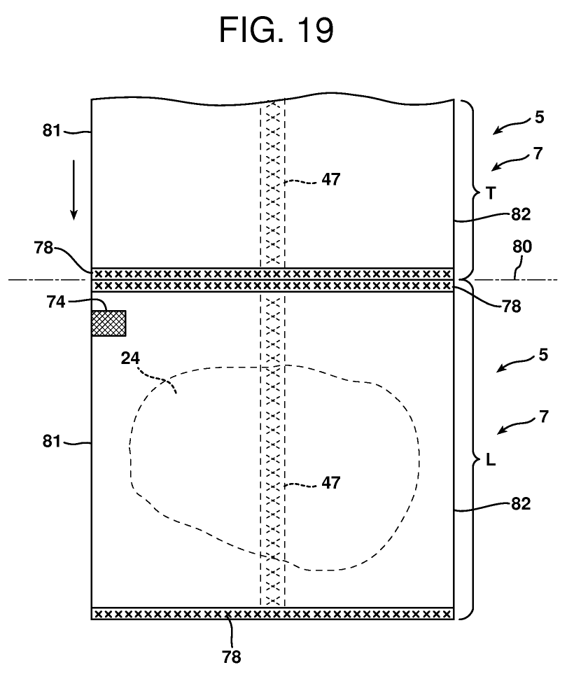

A discrete strip 10 is disposed between first panel 12 and second panel 14, typically near and spaced apart from the first end of the pouch, and spaced apart from the second end of the pouch. The discrete strip 10 can be of any suitable dimension, and will typically be longer in length than in width, with the length of the strip 10 being e.g. greater than two times the width of the strip, e.g. greater than 3, 4, or 5 times the width. A typical dimension for the strip 10 is a width of from about 1 to 1.5 inches and a length of about 7 inches. The strip 10 will be shorter in at least one dimension than the pouch and package. For example, the strip can extend across the transverse width of a pouch made in a HFFS or VFFS process, but will be significantly narrower than the length of the package (see e.g. FIGS. 3 and 4). In one embodiment, the strip will occupy less than 50%, such as less than 40%, less than 30%, less than 20%, or less than 10% of the length of the package. The strip can in another embodiment be shorter in both dimensions than the pouch and package (see e.g. FIGS. 18 and 19). The strip can occupy e.g. less than 50%, such as less than 40%, less than 30%, less than 20%, or less than 10% of each of the length and width of the package. “Near” herein means that the edge of the strip closest to the first end of the pouch and package will be typically within about three inches of the first end of the pouch. The strip 10 can be closer than this, such as within about two inches, one inch, 0.75 inches, 0.5, 0.4, 0.3, 0.2, or 0.1 inches of the first end of the pouch.

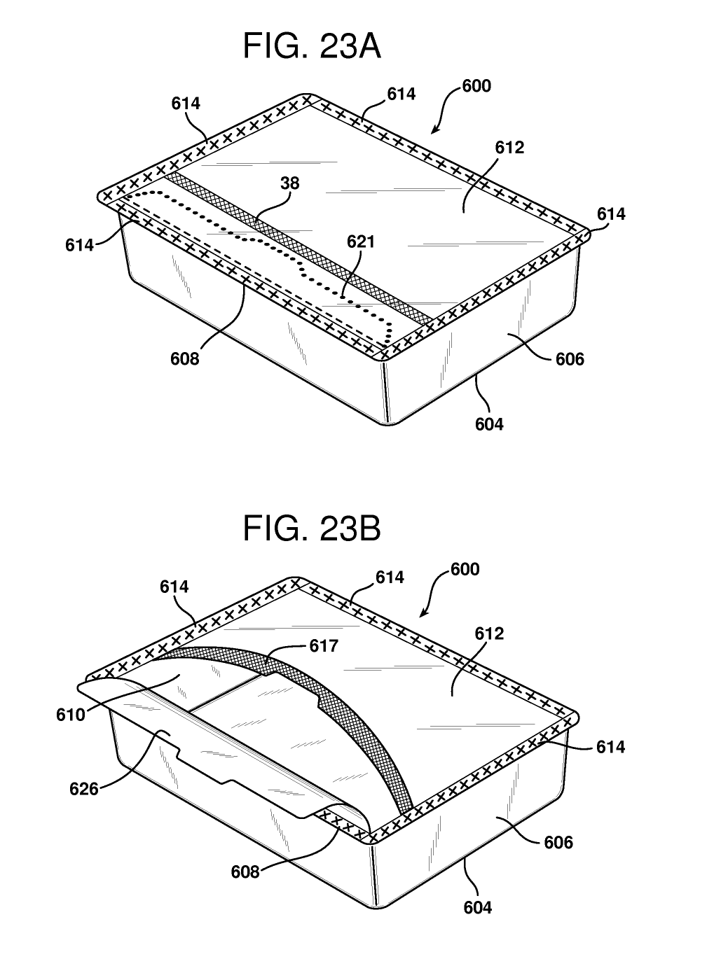

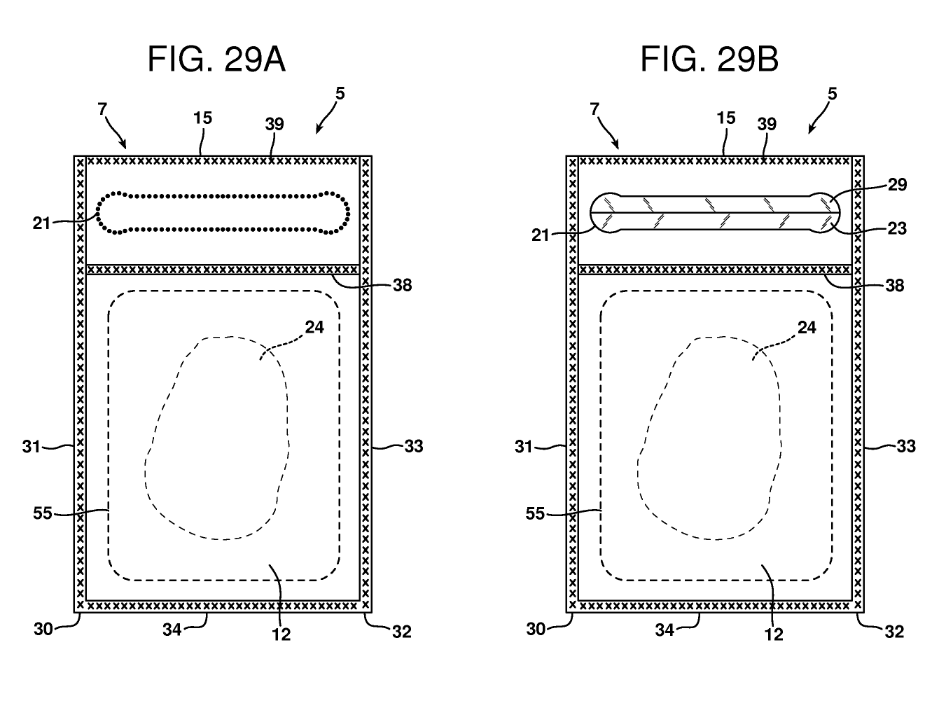

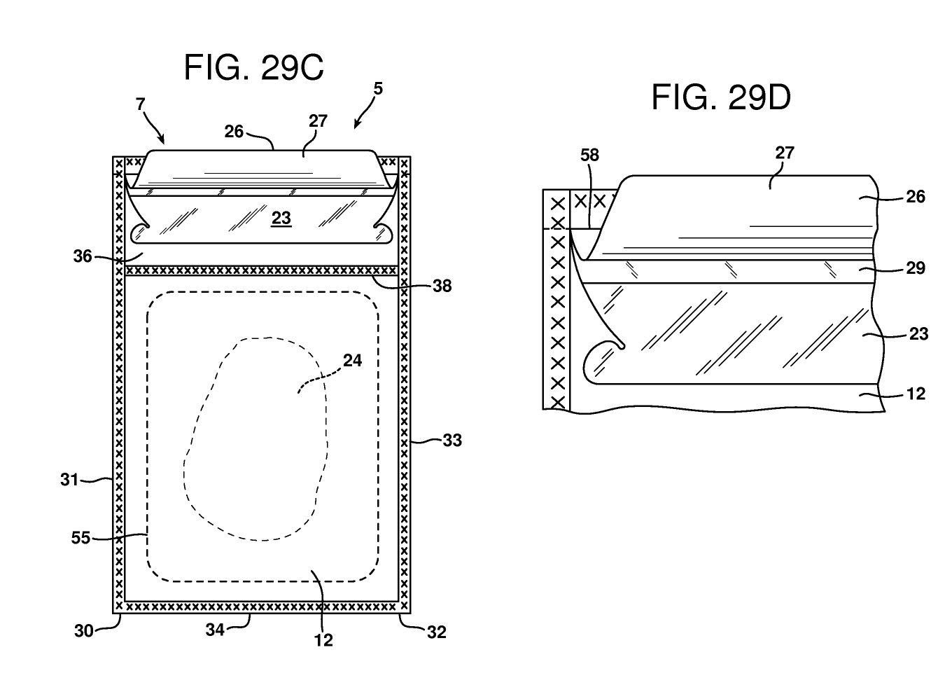

In some embodiments, an opening flap 26 (FIGS. 29C and 29D) or opening flap 626 (see FIG. 23B) provides a device that can be manually grasped and pulled back to open the package, and access the contents of the package. The size of the package, type of materials used for the pouch and the strip, the seal strength of the materials used in the strip, and the type of product being packaged can all have some effect on the choice of the optimal length and dimensions of flap 26 or 626.

Strip 10 comprises a first surface 23 and a second surface 25. These first and second surfaces each comprise a sealant. The first surface 23 is sealed to the inner surface 27 of the first side panel 12, and the second surface 25 is sealed to the inner surface 29 of the second side panel 14 with an easy open seal. The film strip can be of multilayer or monolayer construction.

When a product 24 is placed in the pouch 7, by processes herein disclosed, and the pouch 7 is closed, the package 5 is made.

In some embodiments, at least one die cut, or a portion of a die cut, is disposed closer to the first end of a pouch than the first end of the strip, i.e. the end of the strip closest to the first end of the pouch.

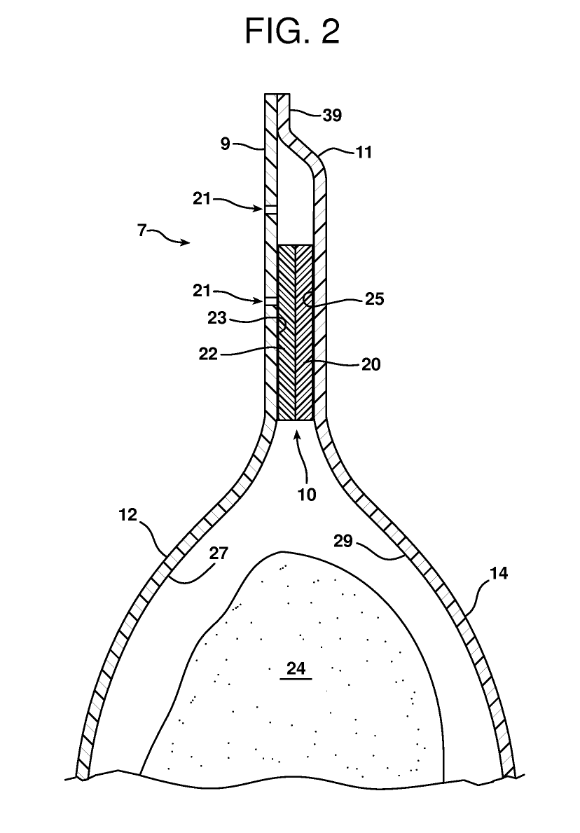

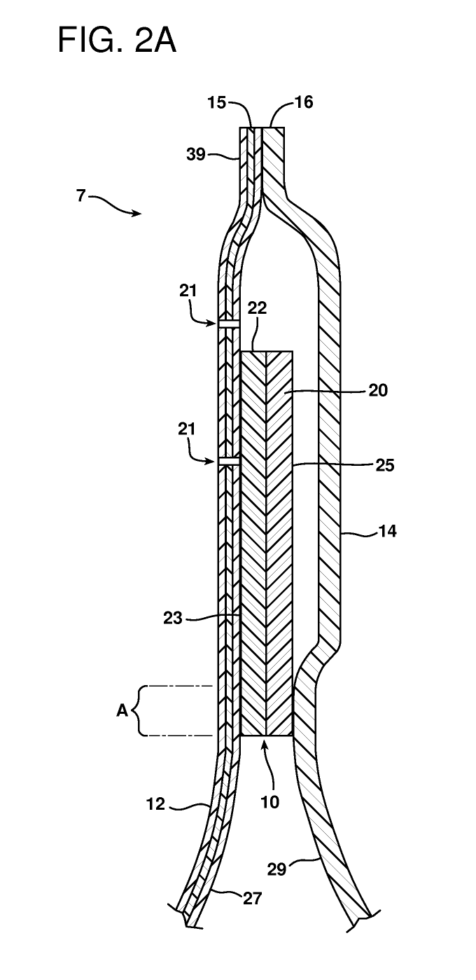

In the embodiments disclosed in the drawings, a second portion of the first surface of the discrete strip is shown, the first portion of the first surface of the discrete strip closer to the first end of the pouch than the second portion. The second portion of the first surface of the strip is anchored to the inner surface of the first side panel at a second location on the first side panel by a seal, shown as anchor 38 in e.g. FIGS. 23A, and 29A to 29C, and as anchor region “A” in e.g. FIGS. 2A, 28B, and 31.

C. Opening Mechanisms and Strip Construction

The package of the invention can be easily manually opened. Any suitable mechanism or combination of mechanisms for obtaining this functionality and feature can be used according to the invention. The following are examples of such mechanisms.

It should be noted that although the embodiments disclosed and illustrated herein are primarily to a strip wherein the second surface 25 of the strip, i.e. the surface of the strip facing the inner surface 29 of the second side panel, is sealed to the inner surface with an easy-open seal, alternatively the strip as disclosed herein can be positioned between the first and second side panels such that an easy-open seal is formed between the first surface of the strip, and the inner surface 27 of the first side panel 12, e.g. by providing a first surface 23 that comprises an easy-open sealant. In another alternative, an easy-open seal can be formed at both the interface of second surface 25 and inner surface 29, as well as the interface of first surface 23 and inner surface 27. In such an embodiment, the strip 10 can be modified to provide easy-open sealants, as disclosed herein for layers 122 and 222, on both surfaces of the strip.

1. Adhesive Failure

In this embodiment, surface 25 and inner surface 29 each comprises a polymeric composition that, when surface 25 is sealed to surface 29, forms an easy-open seal. This seal provides the interface that breaks apart upon manually opening the package. The interlaminar bonds between layers of the discrete strip itself (where the strip is of multilayer construction), the cohesive strength of each layer within the strip or of the single layer of a monolayer strip, and the seal that holds surface 23 to inner surface 27, are stronger than the seal that holds surface 25 to surface 29.

In some embodiments, the polymeric composition of surfaces 25 and 29 will be the same or similar. Useful in these embodiments are the peel systems disclosed in U.S. Pat. Nos. 4,189,519 (Ticknor) (blend of EVA or EMA or EEA with crystalline isotactic polybutylene, and optionally with anhydride grafted EVA); 4,252,846 (Romesberg et al.) (blend of EVA and HDPE, optionally with IO or polybutylene (PBU)); 4,550,141 (Hoh) (blend of IO and polypropylene/ethylene copolymer (EPC)); 4,666,778 (Hwo) (three component blend of PE, that can be LLDPE, LDPE, MDPE, or HDPE, or EVA or EMA, with PBU, and PP or EPC); 4,882,229 (Hwo) (butene-1 polymer or copolymer blended with modified or unmodified LDPE); 4,916,190 (Hwo) (blend of butylene polymer or copolymer, with PE polymer or copolymer (LLDPE, LDPE, MDPE, EVA, EMA, EEA, EBA, or HDPE), with propylene polymer or copolymer); 4,937,139 (Genske, et al.) (propylene polymer or copolymer blended with HDPE); 5,547,752 (Yanidis) (blend of PBU and IO); and 5,997,968 (Dries et al.) (blend of Component 1 (a copolymer of ethylene and propylene or ethylene and butylene or propylene and butylene or ethylene and another-olefin having 5 to 10 carbon atoms or propylene and another-olefin having 5 to 10 carbon atoms or a terpolymer of ethylene and propylene and butylene or ethylene and propylene and another-olefin having 5 to 10 carbon atoms) and Component 2 (HDPE, MDPE, LDPE, LLDPE or VLDPE); these U.S. patents all incorporated herein by reference in their entirety.

In other embodiments, the composition of surfaces 25 and 29 will differ, i.e. dissimilar sealants are used. Useful in these embodiments are the peel systems disclosed in U.S. Pat. Nos. 3,655,503 (Stanley et al.) (LDPE or MDPE sealed to polypropylene (PP), EPC, saran, nylon 6, polycarbonate (PC), polyvinyl chloride (PVC), or polyethylene oxide (PEO); PP sealed to saran, nylon 6, PC, PVC, PEO, IO, phenoxy, or EVA; or nylon sealed to IO); 4,729,476 (Lulham et al.) (a blend of EVA and IO sealed to 10); 4,784,885 (Carespodi) (PP, HDPE, or LLDPE sealed to substantially linear PE (HDPE, LLDPE) blended with a polyolefinic thermoplastic elastomer such as ethylene propylene diene monomer (EPDM), EPM, butyl rubber, halogenated butyl rubber, isoprene rubber, and styrene butadiene rubber); 4,859,514 ((Friedrich et al.) (IO or IO blended with EVA, sealed to a blend of EVA and ethylene butene copolymer (EBC) and PP); 5,023,121 (Pockat, et al.) (a blend of PBU and PP and a third polymeric material selected from EVA, LDPE, LDPE, and IO, sealed to EVA, LDPE, LLDPE, or IO); these U.S. patents all incorporated herein by reference in their entirety.

2. Delamination Failure

In this embodiment, one of the interlaminar bonds between layers of the discrete strip itself (where the strip is of multilayer construction) can be broken. Thus, the interlaminar bond provides the interface that will break apart upon manually opening the package. The seal between surfaces 25 and 29, and between surfaces 23 and 27, and the cohesive strength of each layer within the strip, are stronger than the interlaminar bond. Useful in this embodiment are the peel systems disclosed in U.S. Pat. No. 4,944,409 (Busche et al.), this patent incorporated herein by reference in its entirety.

3. Cohesive Failure

In this embodiment, one of the layers of the discrete strip itself (where the strip is of multilayer construction) or the monolayer discrete strip, fractures when the package is opened. The seal between surfaces 25 and 29, and between surfaces 23 and 27, and the interlaminar bonds between layers of the strip itself (where the strip is of multilayer construction) are stronger than the layer that fractures. Useful in this embodiment is the peel system disclosed in U.S. Pat. No. 6,476,137 (Longo) (internal rupture of a sealant layer comprising a blend of an ionomer having a melt flow index of less than 5, and a modified ethylene/vinyl acetate copolymer having a substantially higher melt flow index, where the melt flow indices of the two polymers in the seal layer differ by at least 10), this patent incorporated herein by reference in its entirety.

Other peel systems useful in connection with the present invention are those disclosed in U.S. Pat. Nos. 4,058,632 (Evans et al.), 4,615,926 (Hsu et al.); 5,128,414 (Hwo); 6,395,321 (Schaft et al.), 7,055,683 (Bourque et al.), and US Patent Publication Nos. 20030152669 (Vadhar et al.) and 2008/0260305 (Shah et al.) (disclosing as easy-open sealant), DuPont APPEEL™ resins, such as those based on EVA, modified EVA, EAA, or modified EAA; polyethylenes such as LDPE and/or EVA blended with PP; LDPE or EVA blended with polybutene-1, or random propylene/ethylene copolymer blended with polybutene-1; EVA or LDPE blended with PP; LDPE blended with EVA and PP; such blends provide an easy-open sealant when adhered to polyethylene sealants); these U.S. patents and publications all incorporated herein by reference in their entirety.

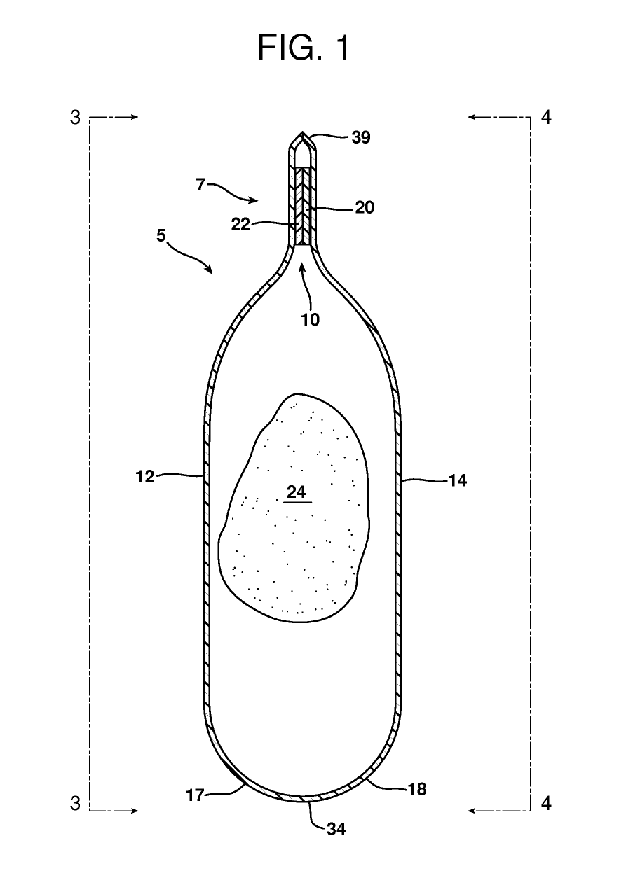

Strip 10 can have any suitable number of layers. In FIGS. 1 and 2, a strip 10 has two layers. Layer 20 comprises a polymeric composition that provides an easy-open seal when sealed at surface 25 to inner surface 29. Layer 22 comprises a polymeric composition that exhibits a relatively strong seal when sealed at surface 23 to inner surface 27.

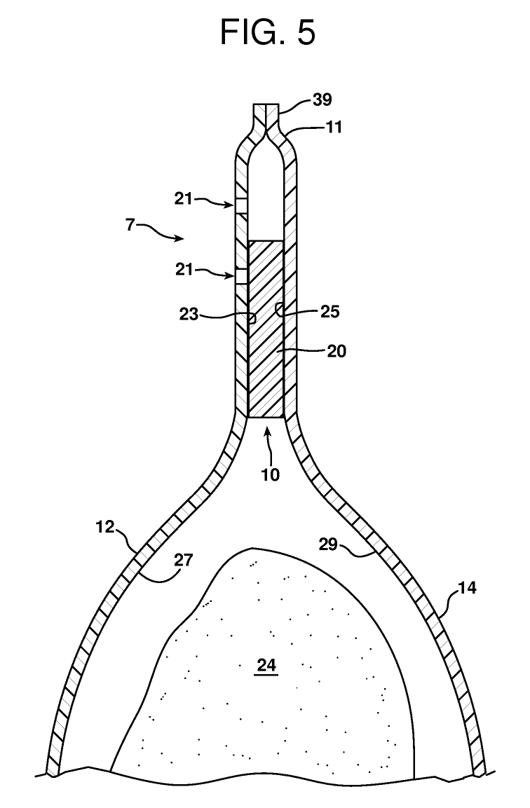

Alternatively, (FIG. 5), discrete strip 10 is of monolayer construction. Layer 20 comprises a polymeric composition and includes first outer surface 23 and second outer surface 25 that can be like those disclosed herein for a multilayer discrete strip.

Referring to FIG. 2A, the first side panel 12 includes at least one die cut 21. During manufacture of the package, strip 10 is sealed to a portion of the inner surface 27, e.g. with a relatively strong heat seal, at anchor region “A”. Die cut 21 of the first side panel is underlain in part by a portion of the strip. The second surface 25 of strip 10 is sealed to inner surface 29 of back panel 14 with an easy-open seal.

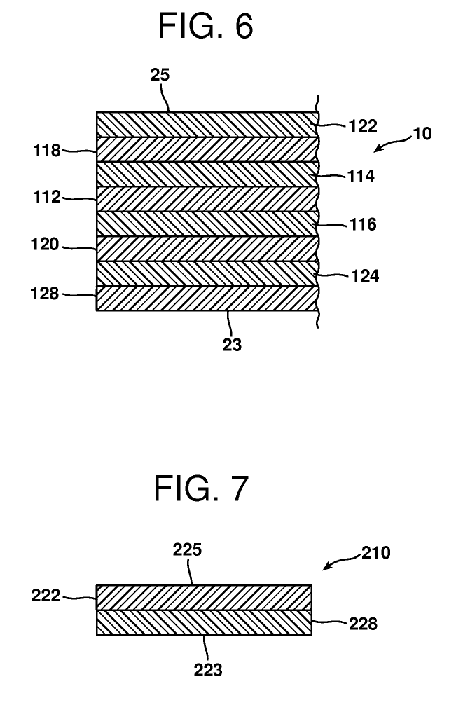

A representative film structure “A1” suitable for use as the film strip 10 according to the invention is shown in FIG. 6. In one embodiment, this film has the composition shown in Table 1.

TABLE 1
(Example 1)

| | | Gauge | Gauge | Gauge |
|---|---|---|---|---|
| Layer | Composition | (thickness %) | (mils) | (μm) |
| 122 | EZ1 | 25.00 | 0.50 | 12.7 |
| 118 | AD1 | 7.50 | 0.15 | 3.8 |
| 114 | 80% NY1 + | 7.50 | 0.15 | 3.8 |
| | 20% NY2 | | | |
| 112 | OB1 | 10.0 | 0.20 | 5.1 |
| 116 | 80% NY1 + | 7.50 | 0.15 | 3.8 |
| | 20% NY2 | | | |
| 120 | AD1 | 7.50 | 0.15 | 3.8 |
| 124 | 65% AD2 + | 17.50 | 0.35 | 8.9 |
| | 35% PE1 | | | |
| 128 | PE1 | 17.50 | 0.35 | 8.9 |

This example of a material suitable as the discrete strip 10 is a barrier film with an easy-open sealant, and is currently used as a barrier/easy-open component of various laminated materials that also include a polyester film component, sold commercially by the Cryovac business unit of Sealed Air Corporation, under designations including H52XXBZ, and H72XXBZ. These are sold as primary packaging materials, i.e. webs that form the main body of the package, not as discrete strips to be used in combination with a primary web.

When used according to the invention, the easy-open sealant layer 122 of A1 exhibits a peel force of typically 2 pounds/inch (ASTM F88). Layer 128 of A1 yields a peel force of typically 8 pounds/inch.

The resins disclosed in Table 1 are identified in Table 2.

TABLE 2

| Material | Tradename Or | |
|---|---|---|
| Code | Designation | Source(s) |
| AD1 | PLEXAR ™ PX1007 ™ | Equistar |
| AD2 | BYNEL ™ 39E660 ™ | DuPont |
| EZ1 | APPEEL ™ 72D727 | DuPont |
| NY1 | ULTRAMID ™ B33 01 | BASF |
| NY2 | GRIVORY ™ G21 | EMS |
| OB1 | SOARNOL ™ ET3803 | Nippon Gohsei |
| PE1 | PE ™ 1042cs15 | Flint Hills |

AD1 is a maleic anhydride modified EVA that acts as a polymeric adhesive (tie layer material).

AD2 is a maleic anhydride modified EVA that acts as a polymeric adhesive (tie layer material).

EZ1 is a compound polymer blend of 65% ionomer (SURLYN™ 1650SB), 30% EVA (ELVAX™ 3134Q), and 5% polybutylene (MONTELL™ PB8640), each by weight of the blend.

NY1 is nylon 6 (polycaprolactam).

NY2 is an amorphous copolyamide (6I/6T) derived from hexamethylene diamine, isophthalic acid, and terephthalic acid.

OB1 is EVOH with about 38 mole % ethylene. PE1 is LDPE.

Example 1 as shown has a total thickness ranging from about 2.0 mils to 3.5 mils.

Core layer 112 of the above film structure can comprise any suitable oxygen barrier material, such as EVOH, and can be blended in any suitable proportion with other polymeric materials or organic or inorganic additives as desired. In one embodiment, intermediate layers 114 and 116 can each comprise 100% semicrystalline polyamide such as nylon 6.

In another embodiment, Intermediate layers 114 and 116 each comprise a blend of an amorphous polyamide and a semicrystalline polyamide.

Tie layers 118 and 120 can comprise any suitable polymeric adhesive that functions to bond two layers together, e.g. EVA, EAO, LDPE, EMA, and anhydride grafted derivatives of these polymers. Tie layers 118 and 120 can be the same, or can differ.

Bulk layer 124 can comprise a suitable polyolefin, such as an EAO; and/or a polymeric adhesive such as those disclosed herein for tie layers 118 and 120.

In one embodiment, first outer layer 122 functions as an easy-open sealant layer of the film, and provides a surface 25 that can be sealed to the inner surface 29. Layer 122 can comprise any suitable material or blend of materials that provides an easy-open peelable seal when adhered to the inner surface 29. Layer 122 comprises EZ1 or any suitable resin or resin blend that provides an easy-open peelable sealant.

Second outer layer 128 functions as a sealant layer of the film, and provides a surface 23 that can be sealed to the inner surface 27. Layer 128 can comprise any suitable material or blend of materials that provides a relatively strong seal when adhered to the inner surface 27. Layer 128 comprises PE1 or any EAO such as EXACT™ 3024, a single-site catalyzed linear ethylene/butene copolymer from ExxonMobil with a density of 0.905 g/cc; or AFFINITY™PL 1888G, a single-site catalyzed branched ethylene/octene copolymer from Dow with a density of 0.9035 g/cc.

Additional materials that can optionally be incorporated into one or more of the film layers, as appropriate, include antiblock agents, slip agents, antifog agents, fillers, pigments, dyestuffs, antioxidants, stabilizers, processing aids, plasticizers, fire retardants, UV absorbers, etc.

In general, strip 10 can have any total thickness desired, and each layer can have any thickness desired, so long as the strip and package provide the desired functionalities. Typical total film thicknesses are from 0.1 mils to 15 mils, such as 0.2 to 12 mils, such as 0.5 mils to 10 mils, 0.8 mils to 8 mils, and 1 mil to 4 mils. Suitable gauges include 1.5 mils, 2 mils (as in Example 1); and 3 mils.

Thus, by way of example, FIG. 7 shows, in another embodiment, a two layer film 210 having a first outer layer 222 compositionally and functionally like layer 122 of FIG. 6, with a first outer surface 225; and having a second outer layer 228 compositionally and functionally like layer 128 of FIG. 6, with a second outer surface 223.

Two, three, four, five, six, seven, and eight layer films can thus alternatively be produced, that each include the layers described above with respect to the film strip of FIG. 7, with additional layers as needed, using suitable polymers such as olefin homopolymers or copolymers.

In some embodiments, such as the film strip of FIG. 7, an oxygen barrier layer is not necessary, for example in the packaging of produce. In these embodiments, the web or webs that comprise the pouch will typically also not have an oxygen barrier layer. In contrast, embodiments of strip 10 that include an oxygen barrier layer will typically be suitable in connection with web or webs for the pouch that include an oxygen barrier layer.

For many products, it is important to ensure hermeticity of the package during storage and distribution. This may be more difficult where one or more die cuts are present in the first side panel of the package. Hermeticity is achieved in various embodiments of the invention with a relatively strong seal anchoring the first side panel to the strip in region “A”, and an easy-open seal sealing the second side panel to the strip (FIG. 2A).

At least one open-loop or close-loop die cut is disposed on the first side panel. Two or more die cuts can be disposed on the first side panel, one at a position closer to the first end of the package than the strip, as well as a second die cut “shadowed by” i.e. underlain by the strip 10. A die-cut segment of material can thus be displaced, e.g. along a hinge line, thus providing a flap, or entirely removed from the first side panel, exposing the upper edge of the discrete strip sealed to the inner surface 27 of first side panel 12. This upper edge of the strip can then be grasped and pulled up, allowing access to the contents of the package.

2. Method of Making a Package

A. Horizontal Form/Fill/Seal (HFFS)

HFFS packaging systems are generally well known to those of skill in the packaging industry, and can be used to make packages of the present invention.

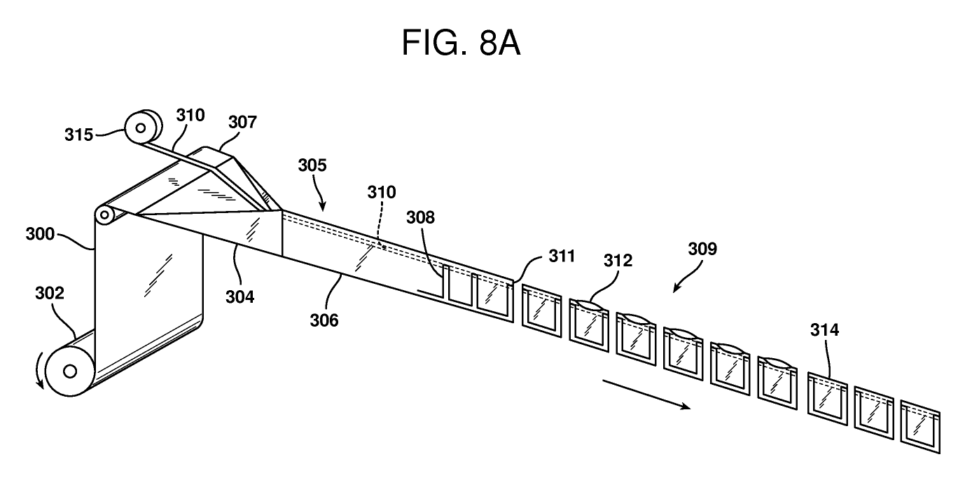

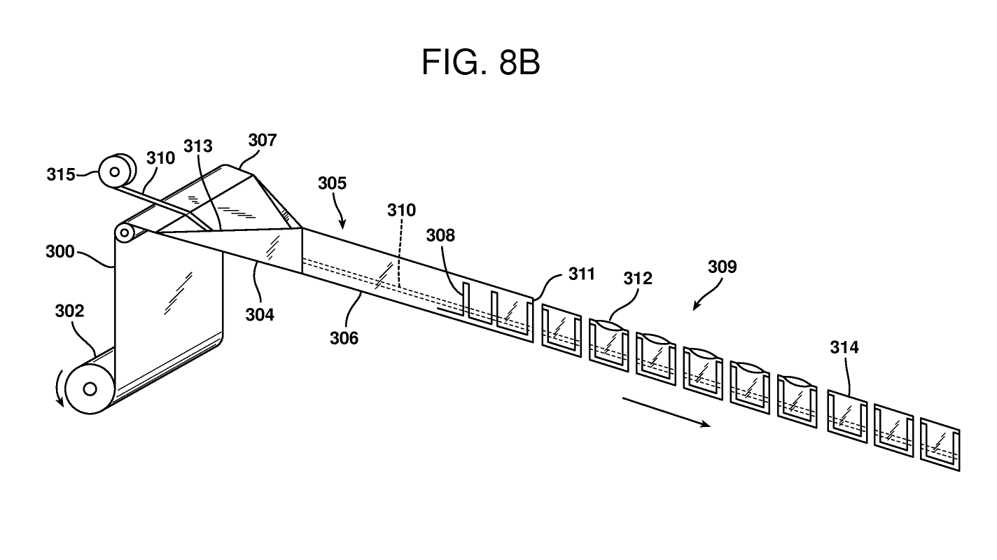

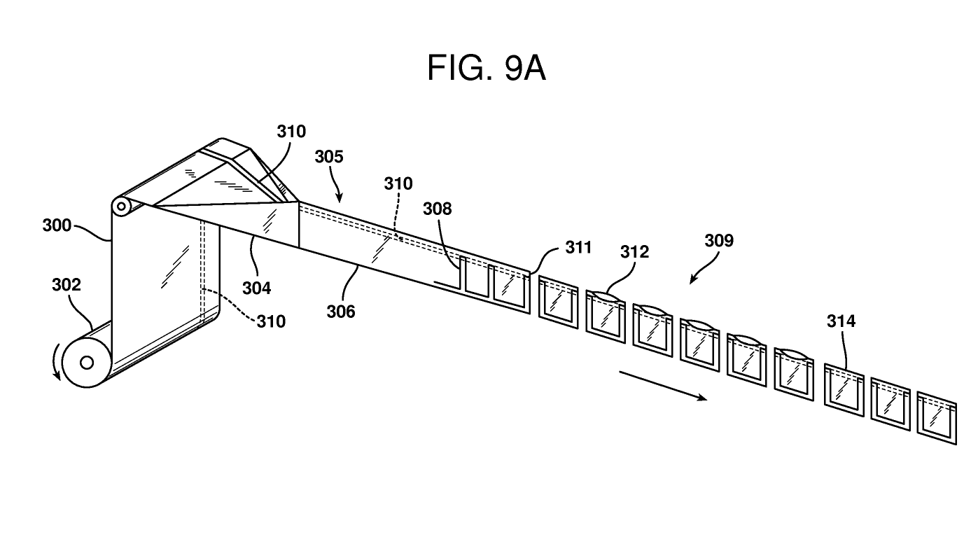

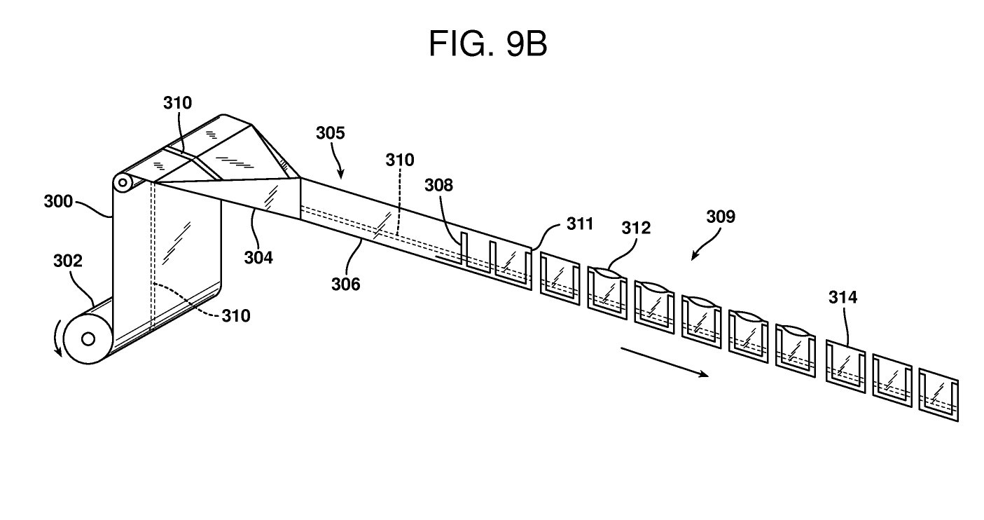

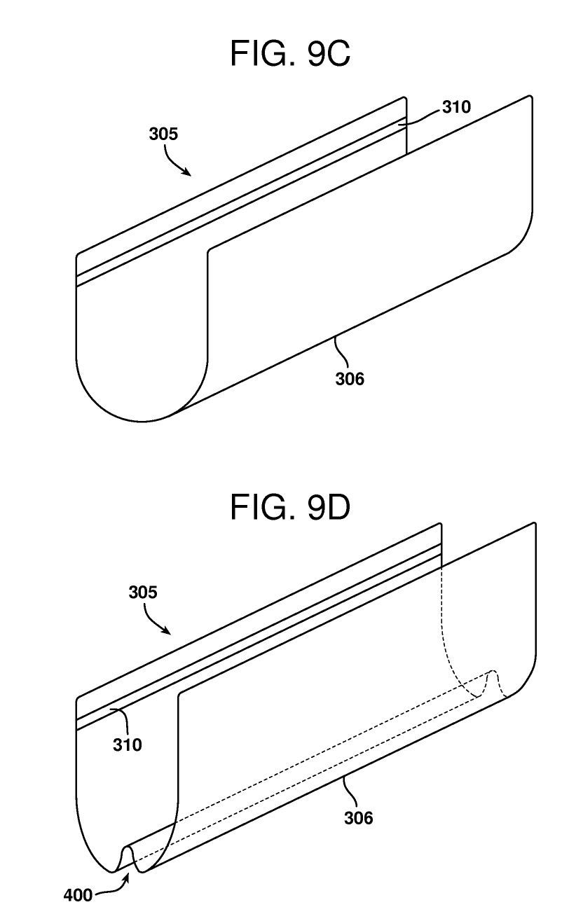

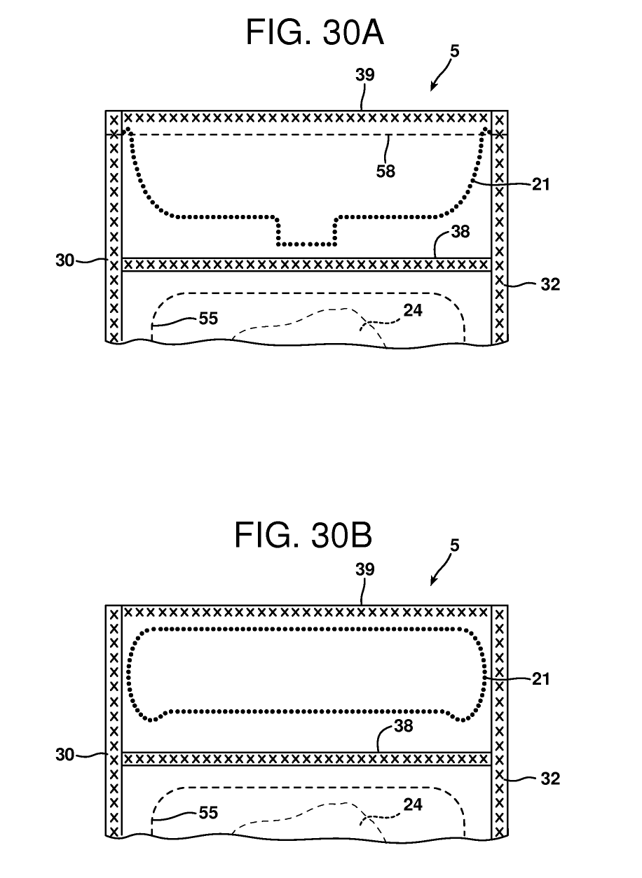

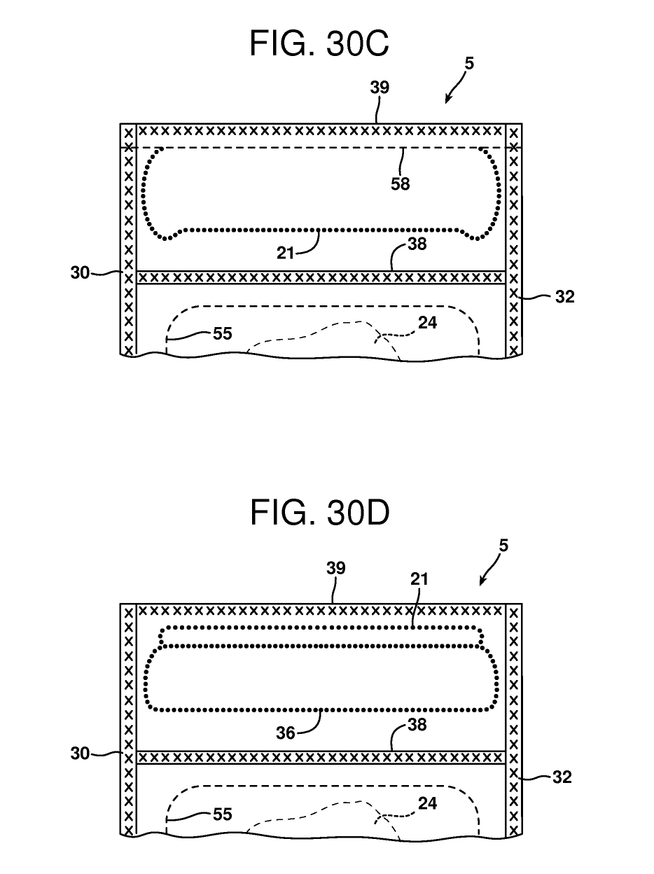

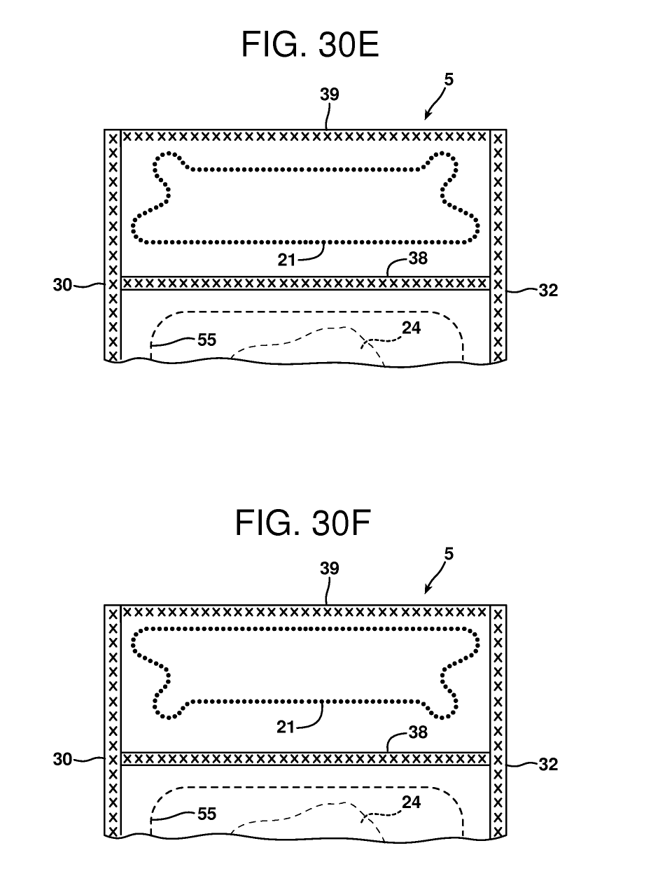

Referring to FIGS. 8A, 8B, and 9A through 9D, lay-flat web 300 is unwound from roll 302, then advanced to forming plow 304 to convert lay-flat web 300 to folded web 305 (typically a centerfold film). The second end of each of the pouches to be made will comprise a second end fold 306. Second end fold 306 therefore is equivalent to second end 34 of FIG. 1. This second end fold can be optionally sealed, or left as a folded second end of the pouch. Side seals 308 are made to define a plurality of vertically arranged pouches 309. Each pouch 309 is cut off from the trailing edge of web 300 by an appropriate cutting mechanism (not shown) at position 311, a product (not shown in FIG. 8, but see product 24 in FIGS. 1 to 5) is inserted or dropped into the open mouth 312 of each pouch, and the pouch mouth 312 is then closed by a suitable sealing mechanism such as a heat sealer (not shown) to create a seal 314. Web 300 includes die cuts made in a predetermined pattern (see FIGS. 29A to 30F) to produce packages according to the invention.

Discrete strip 310, equivalent to strip 10 of FIGS. 1 to 5, can be introduced into the HFFS process in a number of ways. For example, strip 310 can be unwound from a roll 315 in the vicinity of roll 302, and disposed on lay-flat web 300 prior to, or as web 300 is being folded into folded web 305. The strip is disposed on the web near and spaced apart from, and parallel to, the first or second longitudinal edges 307 or 313 of the lay-flat web 300.

The strip 310 can be anchored to the lay-flat web, or the inner surface of the folded web, at any suitable step in the HFFS process, by a suitable sealing mechanism such as a heat sealer (not shown). Strip 310 would thus be installed on the pouch in the same overall HFFS process that achieves production of the pouch, loading of a product into the pouch, and completion of the final package. Strip 310 is incorporated into the pouch material and after cutting and sealing as described hereinabove, and is disposed between and sealed to the two side panels of each pouch as shown in FIGS. 8A, 8B, and FIGS. 1 to 5. Either surface of the strip can be used to anchor the strip to the lay-flat web or folded web.

Alternatively, and referring to FIGS. 9A and 9B, strip 310 is shown as already being anchored on the lay-flat web prior to the start of the HFFS packaging process. This can be accomplished off-site from the processor, e.g. by the supplier of the web roll 302. A disadvantage of this embodiment is the asymmetry caused in the roll profile when the strip 310 is wound onto the roll, caused by the build-up in thickness of the roll in the region where the strip is applied, as the result of repeated winds of the roll.

FIG. 9C is a perspective view of a section of folded web as shown in the HFFS process and apparatus of FIGS. 8A and 8B, and 9A and 9B, as the lay-flat web is folded to create folded web 305. The discrete strip 310 is shown attached to an inner surface 27 of one panel 12 of the folded web 305, such that upon sealing the web to create a pouch, panels 12 and 14 (see FIGS. 1 and 2) will sandwich the discrete strip 310 between them.

The embodiment of FIG. 9D is similar to FIG. 9C, but additionally shows an optional gusset 400 that can be made in the second end fold 306 of the folded web. The gusset can be optionally thereafter heat sealed. A gusseted second end provides a stand-up pouch feature in the final package. Gusseting can be accomplished by any suitable means known to those of skill in the art, such as a second forming plow (not shown) placed in-line in the manufacturing line at a position downstream of the forming plow 304. The bottom area of the folded web takes on a generally “W” shape, i.e. a gusseted shape, in cross-section, with the outside legs of the “W” extending upwardly, and two parallel reverse folds to create the gusseted bottom. Seal opening or holes are previously punched in the inner legs of the “W” shape and aligned with one another so that the two outside plies can be sealed together through these holes. When the seals are made the panels are sealed to one another through the holes. One or more static plows may be mounted above the seal zone to form the gussets. Gusset holes can be die punched by a static die at a hole-punch station which intermittently punches at least two holes at a predetermined position designed to be in general alignment with the side seal, adding rigidity to the gusset portion of the final package. This added rigidity enables the final package to stand up by itself when placed on a flat surface.

At any time during the method of making the package in an HFFS process, a second portion of the first surface of the discrete strip is anchored to the lay-flat web, the folded web, or the inner surface of the first side panel. This can be done e.g. on the lay-flat web prior to supplying the web to the processor, or prior to or as the lay-flat web is advanced to a forming device, or before or after a product is put in the open pouch.

The final package will include a first surface of the strip sealed to an inner surface of a first side panel of the package, and a second surface of the strip sealed to an inner surface of a second side panel of the package with one or both of these seals being an easy-open seal. The sealing of the first and second surface of the strip to the lay-flat web or folded web can occur at any suitable time during the HFFS process. The sealing of the first surface of the strip to the lay-flat web or folded web can occur at a different time than the sealing of the second surface of the strip to the lay-flat web or folded web. The anchoring step described above can provide this sealing function for one of the surfaces of the strip.

B. Vertical Form/Fill/Seal (VFFS)

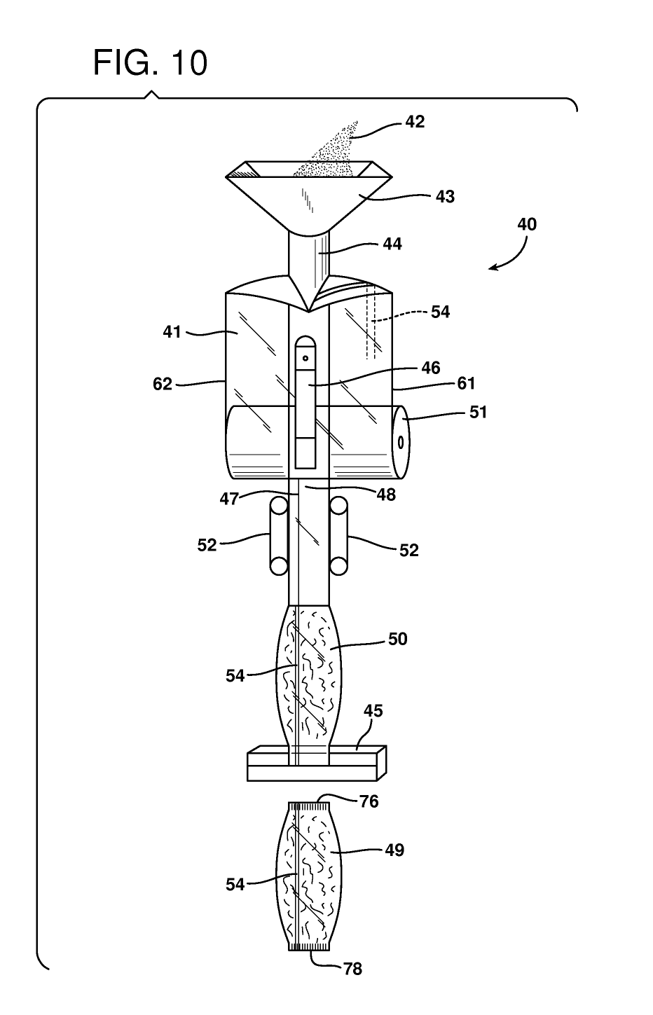

FIG. 10 schematically illustrates a VFFS apparatus that can be used in conjunction with the apparatus and process according to some embodiments of the present invention. VFFS packaging systems are generally well known to those of skill in the art, and described for example in U.S. Pat. Nos. 4,589,247 (Tsuruta et al), 4,656,818 (Shimoyama et al.), 4,768,411 (Su), and 4,808,010 (Vogan), all incorporated herein by reference in their entirety.

Apparatus 40 utilizes a lay-flat web 41 as a rollstock. Web 41 includes die cuts made in a predetermined pattern (see FIGS. 29A to 30F) to produce packages according to the invention. Product 42 is manually or mechanically supplied to apparatus 40 from a source (not illustrated), from which a predetermined quantity of product 42 reaches the upper end portion of forming tube 44 via funnel 43, or other conventional means. The packages are formed in a lower portion of apparatus 40, and web 41 from which the packages are formed is fed from feed roll 51 over certain forming bars (not illustrated), is wrapped about forming tube 44 (sometimes known as a “sailor's collar” or “forming collar”) and is provided with a longitudinal fin seal or lap seal 47 by longitudinal heat sealing device 46, resulting in the formation of a vertically-oriented folded web in the form of a tube 48. Transverse heat seal bars 45 operate to close and seal horizontally across the lower end of vertically-sealed tube 48, to form a pouch 49 which is thereafter immediately packed with product 42. Film drive belts 52, powered and directed by rollers, as illustrated, or by suitable alternative motive means, advance tube 48 and pouch 49 a predetermined distance, after which seal bars 45 close and simultaneously seal horizontally across the lower end of vertically-sealed tube 48 as well as simultaneously sealing horizontally across upper end of sealed pouch 49, to form a product packaged in sealed pouch 49. The next pouch 50, thereabove, is then filled with a metered quantity of product 42, forwarded, and the packaging cycle is repeated. It is conventional to incorporate with the seal bars 45 a cut-off knife (not shown) which operates to sever a lower sealed pouch 49 from the bottom of upstream pouch 50.

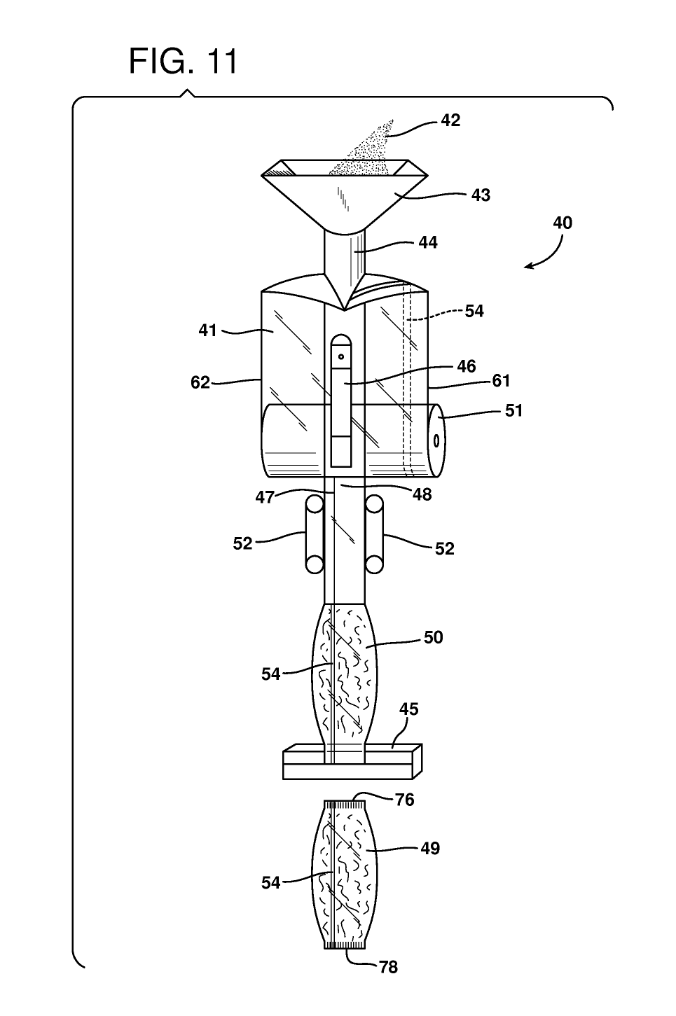

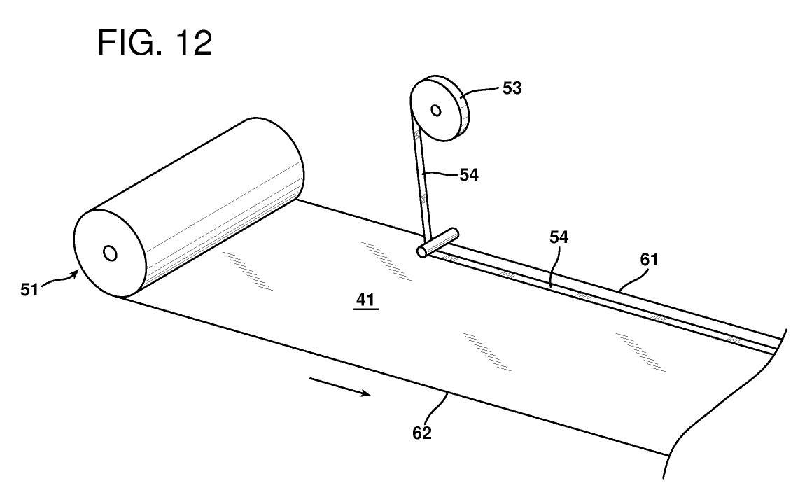

Lay-flat web 41 of FIGS. 10 and 11 will in operation travel vertically upward from roll 51 to the forming tube 44, and then vertically downward for the remaining process steps. Discrete strip 54 is unwound from roll 53 (FIG. 12) to dispose strip 54 onto web 41 before, or as, web 41 is wrapped about forming tube 44, such that strip 54 is trapped between inner surfaces of the web 41 in the region near and spaced apart from where the longitudinal seal 47 is to be made.

FIG. 12 discloses the roll 51 of lay-flat web 41 according to one embodiment of the invention. Strip 54 is fed from roll 53 onto lay-flat web 41, the strip 54 disposed on web 41 near and spaced apart from, and parallel to, first or second longitudinal edges 61 or 62 of lay-flat web 41.

Alternatively, and referring to FIGS. 11 and 13, discrete strip 54 is already installed on the lay-flat web prior to the start of the VFFS packaging process. This can be accomplished off-site from the processor, e.g. by the supplier of the feed roll 51, but with the same disadvantage discussed for the embodiment of FIGS. 9A and 9B.

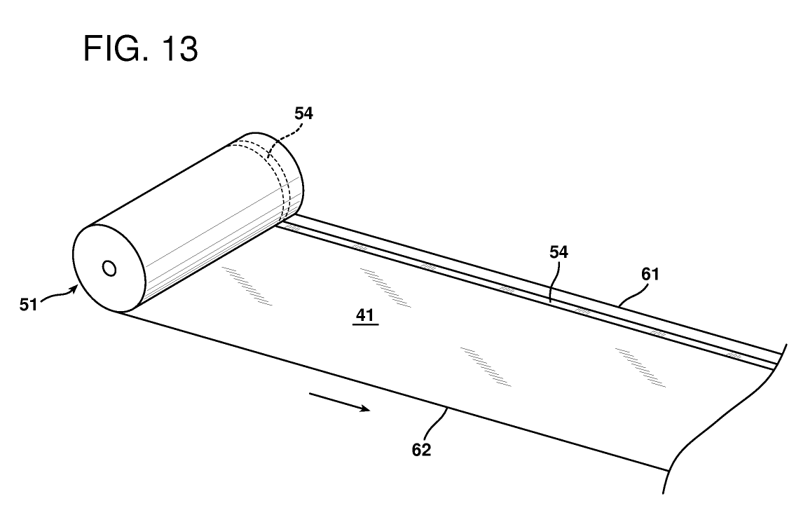

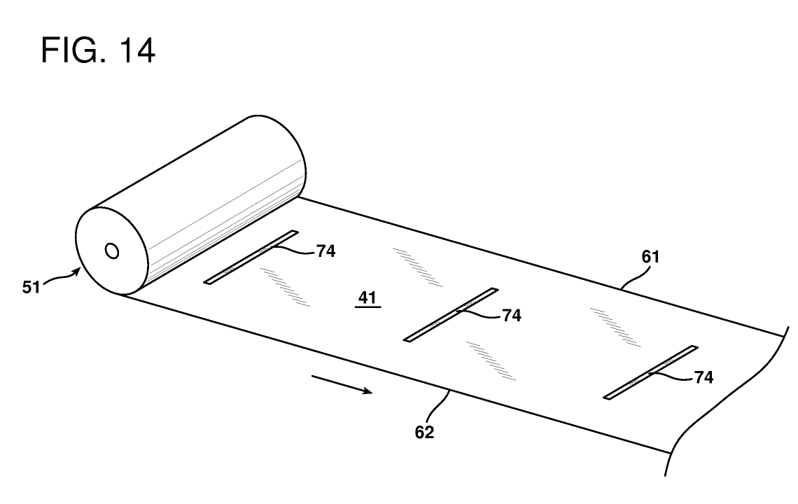

Alternatively (FIG. 14) discrete strip 74 is already installed on the lay-flat web prior to the start of the VFFS packaging process. This can be accomplished off-site from the processor, e.g. by the supplier of the feed roll 51. The disadvantage associated with the embodiments of FIGS. 9 and 13 can be avoided by spacing the consecutive strips 74 such that they are staggered as installed in winds on the roll 51, so that they are installed on the roll in a manner that avoids or minimizes roll asymmetry. The strips 74 of FIG. 14 are disposed on the web 41 spaced apart from, and perpendicular to, the first and second longitudinal edge 61 and 62.

In some embodiments, e.g. FIG. 14, at least one of the web and the discrete strip carries a registration device. Printed indicia can be in the form of registration marks, such as eye-spots. Those skilled in the art will be familiar with the use of eye-spots and registration marks in processing web material in packaging operations. Registration marks are printed in uniformly spaced fashion along or near an edge of the web or strip, and facilitate the controlled production of packages of the invention, and can be printed in conjunction with other decorative printing.

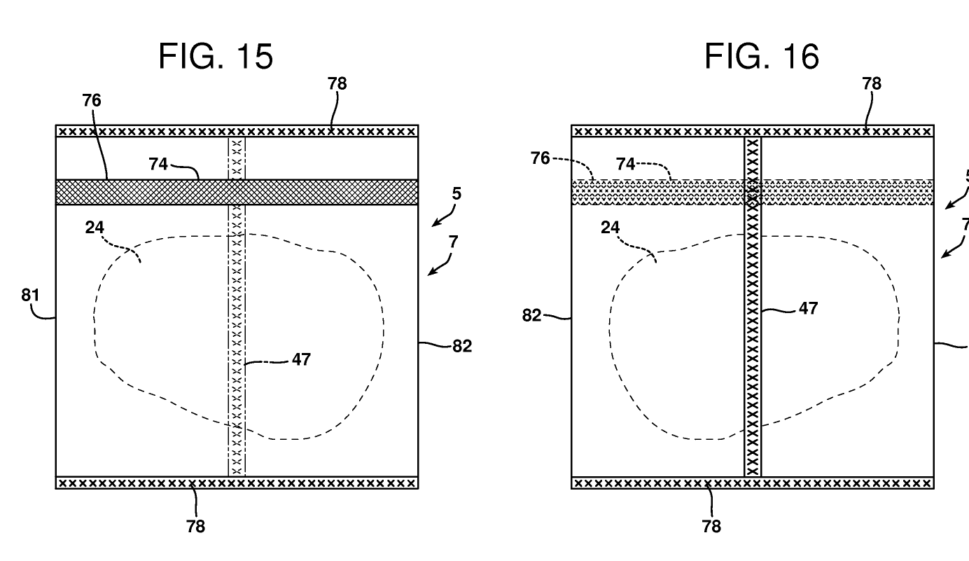

FIG. 15 shows a front view of a VFFS package 5 made according to the embodiment of FIG. 14, and including a pouch 7 comprising first and second transverse seals 78, folded side edges 81 and 82, discrete strip 74, longitudinal seal 47; and product 24. Strip 74 is anchored to the inner surface of the first side panel of the pouch in region “A” (see FIG. 2A), and to the second side panel of the pouch. FIG. 16 shows a back view of package 5.

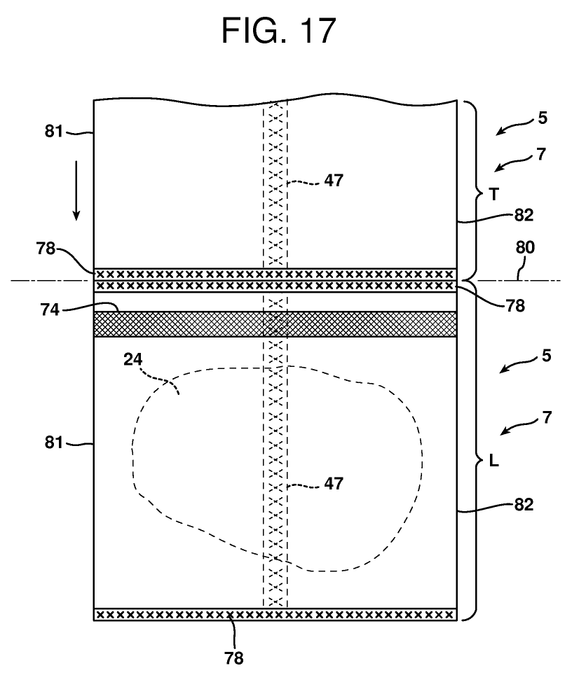

Discrete strip 74 can extend entirely across the transverse width of pouch 7 (FIGS. 15 to 17) or across selected segments of the pouch (FIGS. 18 and 19). In FIG. 17, a leading or downstream pouch “L” includes a transverse bottom and top seals 78, folded side edges 81 and 82, strip 74, and longitudinal seal 47. Trailing or upstream pouch “T” has features similar to leading pouch “L”. Leading pouch “L” is severed from upstream pouch “T” at cut line 80, and the seals 78, as well as the anchor 38 (see e.g. FIG. 30A) that anchors discrete strip 74 to the inner surface of the front panel of the pouch in region “A”, are made by suitable sealing equipment commonly used in VFFS packaging processes, such as heat sealing equipment, not shown.

Die cuts 21 and optionally 36, present in lay-flat web 41 and the first side panel of the package, are not shown in all of the drawings, e.g. in FIGS. 3, 4, and 12 through 21B.

In embodiments where strip 74 extends across only selected segments of the pouch, easy-open access to the package will be proportionate to that part of the package occupied by the strip. Thus, In FIG. 18, strip 74 is relatively small, and centrally located within the region of seal 78. This embodiment provides easy-open access to pouch L through a relatively narrow opening defined by strip 74. In FIG. 19, a very small generally square shaped strip permits only a small easy-open access opening, functioning effectively as a pour spout. In these embodiments, the lateral extent of die cuts 21 and 36 can be proportionately small.

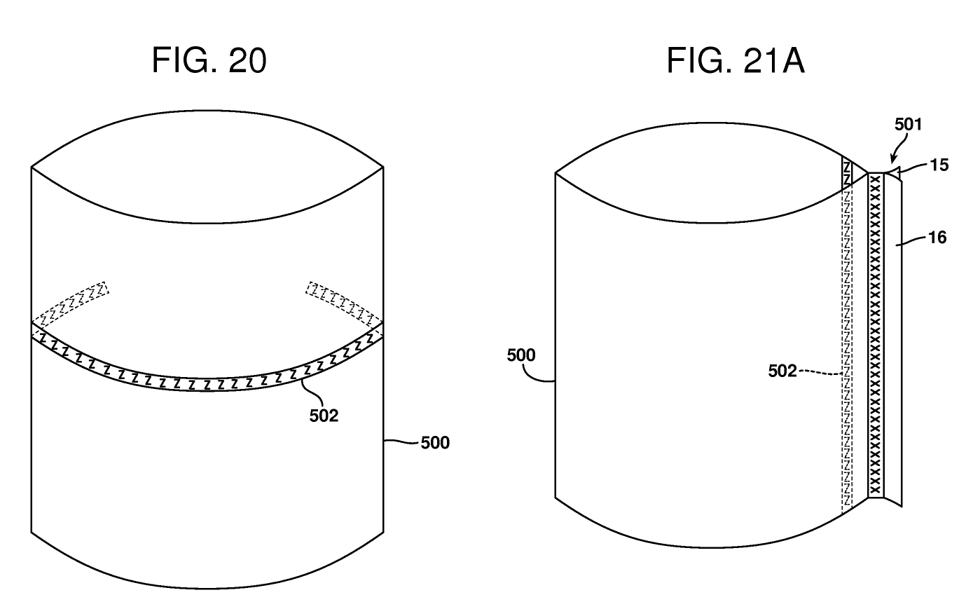

FIG. 20 shows folded web 500 in an embodiment in which discrete strip 502 spans one entire side panel, as well as a portion of the other side panel of the folded web. Thus, the discrete strip of the invention can occupy one side panel of a package, and part of a second side panel of the package.

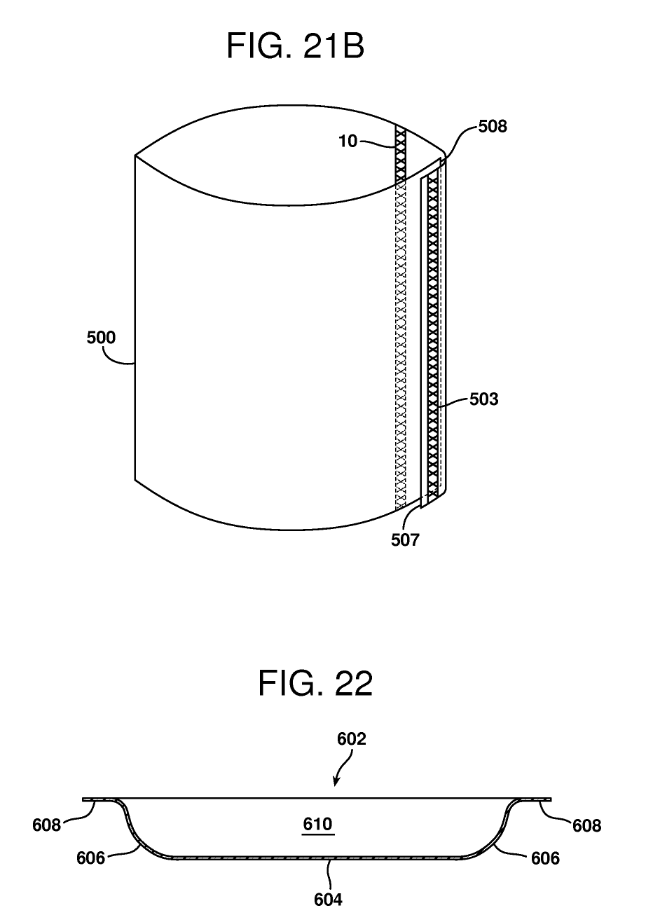

FIG. 21A shows folded web 500 in which the discrete strip 502 is sealed to a longitudinal portion of the folded web, and is positioned near and spaced apart from fin seal 501, formed as disclosed hereinabove. A finished package made according to FIG. 21A will thus look like the packages of FIGS. 3 and 4, when these are viewed at right angles to their position in FIGS. 3 and 4, i.e. with the strip 10 to the right side of each package, and the second end 34 representing a fold. The embodiment of FIG. 21A thus provides a method of producing packages on a VFFS apparatus where the longitudinal seal of the package effectively becomes the first end of the finished package (discounting any unsealed material between the longitudinal seal and the top edge of the package). The apparatus and methodology of U.S. Pat. No. 6,293,073 (Caudle) this patent incorporated herein by reference in its entirety, can be utilized in combination with the teachings herein, to produce packages according to this embodiment. A point of distinction is that in the present invention, the transverse seals will typically (although not necessarily) be rectilinear, whereas the transverse seals disclosed in Caudle '073 are wavy or sinusoidal.

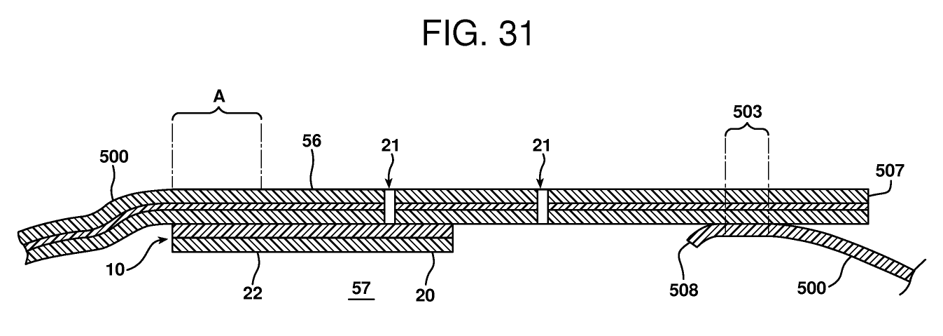

Alternatively (FIG. 21B), a package like the embodiment of FIG. 21A is shown, but where a lap seal 503 is shown, similar to the lap seal 503 of FIG. 31 (see below) wherein discrete strip 10 is sealed to a longitudinal portion of the folded web, near a first longitudinal edge 507 of the folded web, and is positioned near and spaced apart from lap seal 503 of the folded web, formed as disclosed hereinabove. In this as well as the other processes disclosed herein, a lap seal can be used in lieu of a fin seal when making a longitudinal seal according to the invention. A finished package 5 according to FIG. 21B has a product therein; the two longitudinal ends of the package are closed by a transverse seal; the lap seal runs down the middle or spine of the package, the package bounded on both ends by the trans-verse seals; and a discrete strip is anchored to an interior surface of the folded web.

At any time during the method of making the package in an VFFS process, a second portion of the first surface of the discrete strip is anchored to the lay-flat web, the folded web, or the inner surface of the first side panel. This can be done on the lay-flat web prior to supplying the web to the processor, or prior to or as the lay-flat web is advanced over a forming device, or before or after a product is put in a pouch.

As with the HFFS process, the sealing of the first and second surface of the strip to the lay-flat web or folded web can occur at any suitable time during the VFFS process. The sealing of the first surface of the strip to the lay-flat web or folded web can occur at a different time than the sealing of the second surface of the strip to the lay-flat web or folded web. The anchoring step described above can provide this sealing function for one of the surfaces of the strip.

With respect to FIGS. 21A and 21B, although the folded web is shown in an open configuration, with the strip sealed along a first surface to the interior of the folded web, it should be understood that both the first and second surfaces of the strip 502 or 10 are sealed to an interior surface of the folded web.

C. Lidstock/Formed Web

FIGS. 22, 23A, and 23B illustrate in another embodiment the use of a formed web, e.g. a tray, and a non-formed web, e.g. a lidstock, used in connection with the invention. Tray 602 will typically be made during the packaging process. Thermoforming equipment, available from e.g. Multivac, Tiromat, Ulma or Rapid Pak, is used to convert flat thermoplastic forming web into formed pockets to create trays for containing product such as food, various industrial and consumer items and sterile medical products. Trays are formed from a lower web by heat and pressure, and can be loaded with product manually or automatically on the machine. After that, the packages are vacuumized or backflushed with modified atmosphere (if required), hermetically sealed to an upper web, separated, and removed for distribution or storage. Alternatively, pre-formed trays can be used.

Each tray 602 has a tray bottom 604, tray sides 606, and a tray flange 608 along its perimeter to which the lidstock 612 can be sealed by heat or other means. Tray bottom 604 and tray sides 606 define tray cavity 610. Prior to any thermoforming step, tray 602 can be of any suitable thickness, e.g. from 2 to 30 mils thick, and any suitable construction.

If a pre-made tray is used according to the invention, it can be rigid or semi-rigid, can be in the form of a flat or shaped tray, and can be made from any suitable material, including solid or expanded embodiments, such as PP, polystyrene, polyamide, 1,4-polymethylpentene (e.g. TPX™ available from Mitsui), or crystallized polyethylene terephthalate (CPET). A tray liner can optionally be used that adheres to the surface of the pre-made tray on which the product is to be placed. This liner can be of any suitable design, and can be a multi-layer structure with at least one layer with gas-barrier properties. Such a liner can be adhered to the tray by heat lamination, extrusion lamination, extrusion coating, adhesives, corona treatment, etc. Tray 602 can be a flexible or semi-rigid, or rigid formed web.

Referring to FIGS. 23A and 23B, a package includes tray 602 to which lidstock 612 has been sealed with perimeter seal 614. Lidstock 612 is typically a lay-flat web formulated to function as a lid on a formed web, and can be any suitable monolayer or multilayer thermoplastic film as described herein with respect to webs useful in connection with the present invention. Lidstock 612 includes a discrete strip (see e.g. FIGS. 29C and 29D) which has been anchored (anchor 38 can be seen in FIGS. 23A and 23B) to the lidstock. The discrete strip has a sealant on a first surface thereof, i.e. the surface sealed to the lidstock; and an easy-open sealant on a second surface thereof, i.e. the surface sealed to the tray flange of the formed web. The strip has the easy-open characteristics and composition discussed herein with respect to the discrete strip of HFFS or VFFS packages. The strip is disposed between the lidstock and the tray flange such that the strip is trapped between and sealed to the lidstock and tray flange. The first side panel at die cut 621 (see also FIG. 30A) can be pulled back manually toward the end of the package, along hinge line 58, and the first side panel is grasped so that the package is easily opened and product can be removed as desired.

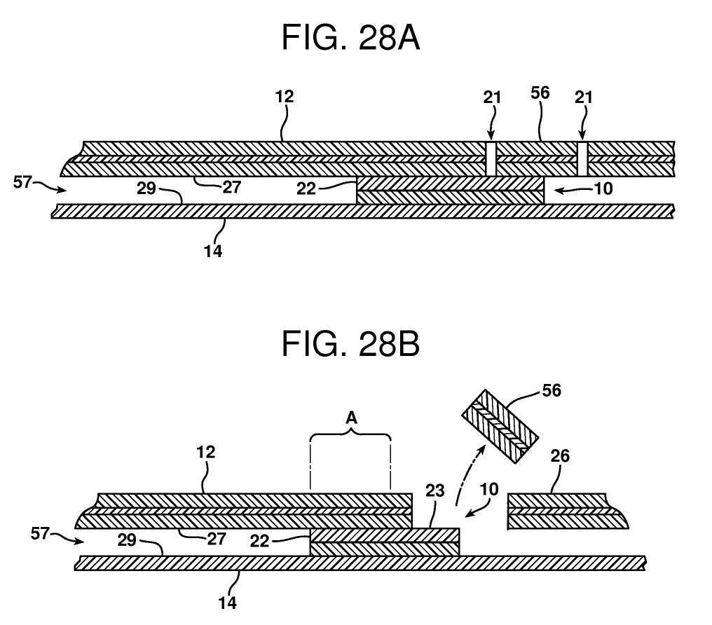

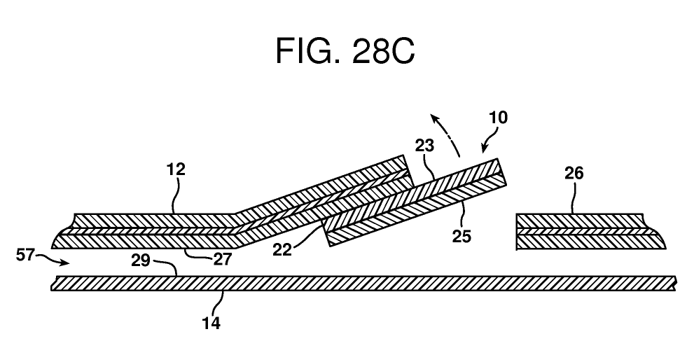

Alternatively (see FIGS. 28A, B, and C, and FIGS. 29A and 29B), a die-cut segment can be removed completely from the first side panel, providing access to the interior of the package.

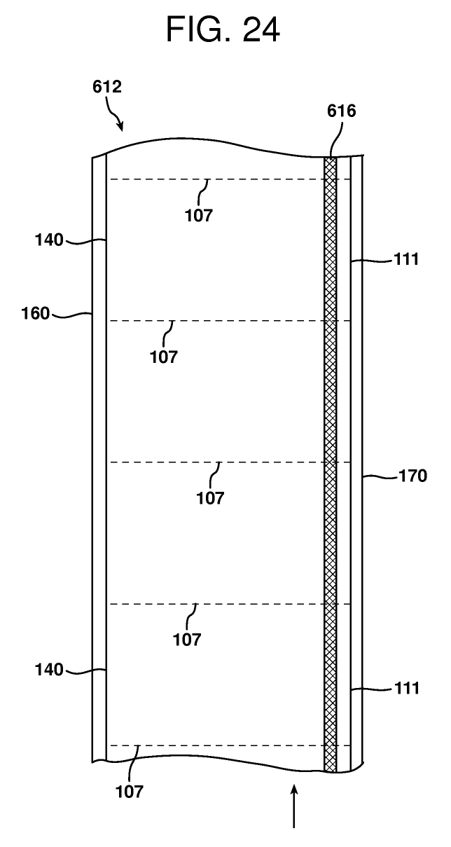

Referring to FIG. 24, dotted lines 107 indicate the location at which lidstock 612 is sealed and cut, e.g. perimeter heat sealed and cut, in registered fashion by otherwise conventional means as discussed herein, e.g. in thermoforming equipment, to create individual packages. Lines 107 represent what will become the side edges and seals of individual packages when lidstock 612 is advanced into a packaging system where it is progressively fed over filled trays, sealed to the trays, and cut to create finished packages. Lines 111 and 140 represent what will become the first and second end respectively of individual packages. Lidstock 612, as rolled up, and as it feeds into thermoforming equipment, has a second lateral edge 160 and first lateral edge 170. During the sealing and cutting operation to make individual, filled packages, the web will be cut such that the lidstock material between lines 170 and 111, and between lines 160 and 140, will be removed as scrap.

FIG. 24 shows strip 616 disposed on lidstock 612 near, parallel to, and spaced apart from, line 111. Strip 616 can be preinstalled on lidstock 612 by the supplier of the lidstock, as in the embodiments of FIGS. 9A and 9B, 11 and 13. Alternatively, strip 616 can be installed on the lidstock during the packaging process, as in the embodiments of FIGS. 8A and 8B, 10, and 12.

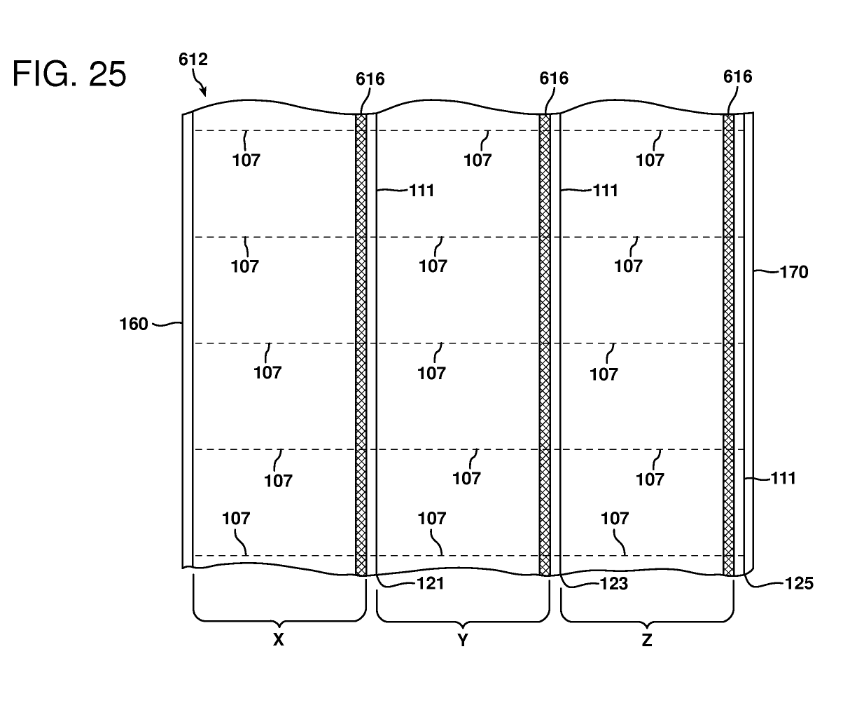

FIG. 25 shows an alternative embodiment of FIG. 24, in which the lidstock is produced as described above, but “three across”, so that when run in a packaging machine, with suitable machine die set-ups, three, six, etc. packages can be made simultaneously. In addition to the seal and cut steps at locations 107, the web is cut longitudinally along lines 121, 123, and 125 respectively, so that individual packages made from the longitudinal portion “X” of FIG. 25 will have a first end 121; individual packages made from the longitudinal portion “Y” of FIG. 25 will have a first end 123; and individual packages made from the longitudinal portion “Z” of FIG. 25 will have a first end 125. The discrete strip can instead be positioned at right angles to the direction of travel of web 612, and can be preapplied to the web, as in FIG. 14.

At any suitable time during the method of making the package having a lidstock and formed web, the first surface of the discrete strip is anchored to the lay-flat web. This can be done on the lay-flat web prior to supplying the web to the processor, or before or during the step of sealing the lidstock to the formed web. The sealing of the second surface of the strip to the formed web, with an easy-open seal, can be done at any time during or during the step of sealing the lidstock to the formed web.

D. Continuous Horizontal Packaging

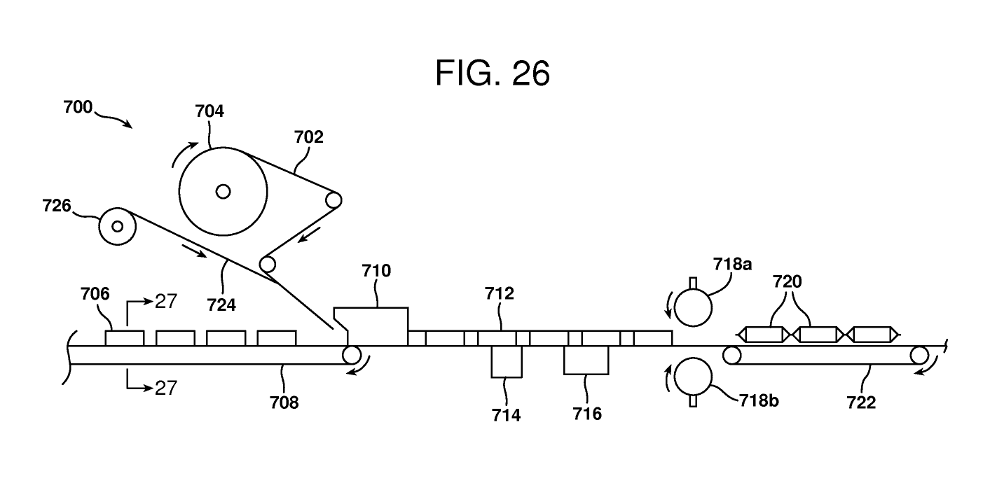

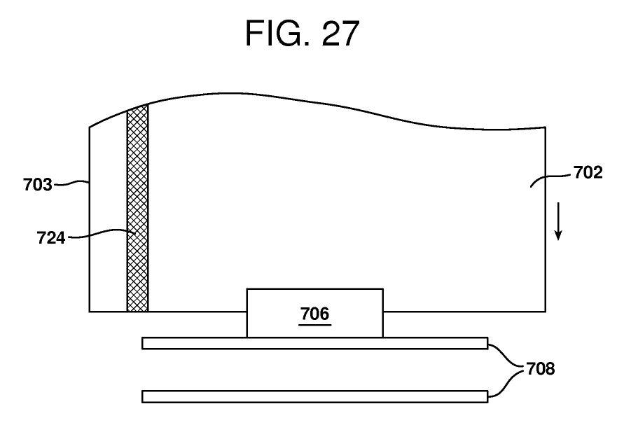

In another embodiment, and referring to FIGS. 26 and 27, the package of the invention can be made using a continuous HFFS process and apparatus such as those used for packaging bakery and other goods, sometimes known as Flow Wrap, Flow-Wrap or Flow wrapping machines or systems, and available from manufacturers/suppliers such as Ilapak, ULMA, and Bosch.

FIG. 26 shows such a process and apparatus 700, but one in which a discrete strip 724 is installed into a package. Lay-flat web 702 is drawn from roll 704 and advanced to forming device 710. As this occurs, a series of products 706 is advanced along conveyor 708 to forming device 710, and strip 724 is drawn from roll 726 and advanced to forming device 710. Web 702 is formed by forming device 710 into folded web 712. This folded web will be like the folded web described above with respect to VFFS embodiments, but in a substantially horizontal orientation. Folded web 712 wraps around products 706. A longitudinal sealing device that can be part of forming device 710 forms a lap or fin seal (of the type disclosed above with respect to VFFS embodiments) typically at the bottom of the folded web, but can also be embodied as a fin seal along a longitudinal edge of the finished package. The lap or fin seal is typically a heat seal. An alternative is to have a separate sealing device 714 to produce the lap or fin seal. The products travel downstream from forming device 710 and sealing device 714 to transverse sealing device 716 where the folded web is transversely sealed in areas of the folded web between adjacent products. Such seals are typically heat seals. The products are advanced from transverse sealing device 716 to cutting device 718a and 718b, where the formed and longitudinally and transversely sealed folded web is severed in areas of the folded web between adjacent products, in or near the transverse seals, such that individual packages 720 are produced.

Alternatively, the sealing function of transverse sealing device 716 and the cutting function of cutting device 718a and 718b can be combined at a single station, rather than being performed at separate locations on the production path.

Web 702 and strip 724 can be of any suitable dimension and composition, such as those disclosed herein. As strip 724 is fed to forming device 710, it can be brought into contact with, and optionally anchored to a surface of web 702. This embodiment is shown in FIGS. 26 and 27, where strip 724 is shown as anchored parallel to, spaced apart from, and near a longitudinal edge 703 of web 702 as it progresses toward forming device 710. Alternatively, strip 724 can be fed into forming device 710, and then incorporated into folded web 712 by anchoring the strip to the interior surface of the web adjacent to the area of the formed web in which the lap or fin seal is made, and in a manner and format analogous to the embodiment of the VFFS pouch and package of FIGS. 10 and 21A and 21B, but in a horizontal rather than vertical position. In another embodiment, strip 724 can be pre-applied to web 702 by the supplier of the web, analogous to the embodiment of the VFFS pouch and package of FIG. 13, and the HFFS pouch and process of FIGS. 9A and 9B. In another embodiment, the strip can be positioned at right angles to the direction of travel of web 702, and can be preapplied to the web, as in FIG. 14. The resulting packages will in this particular embodiment be like those illustrated in FIGS. 15 and 16.

As with the HFFS and VFFS process, the sealing of the first and second surface of the strip to the lay-flat web or folded web can occur at any suitable time during the method of making the package in a continuous horizontal packaging process. The sealing of the first surface of the strip to the lay-flat web or folded web can occur at a different time than the sealing of the second surface of the strip to the lay-flat web or folded web. This can be done on the lay-flat web prior to supplying the web to the processor, or prior to or as the lay-flat web is advanced to a forming device, or before or after advancing a product to a forming device. The anchoring step described above can provide this sealing function for one of the surfaces of the strip. The second surface of the strip will be sealed to the lay-flat web or folded web with a easy-open seal.

E. Side Seal Bags

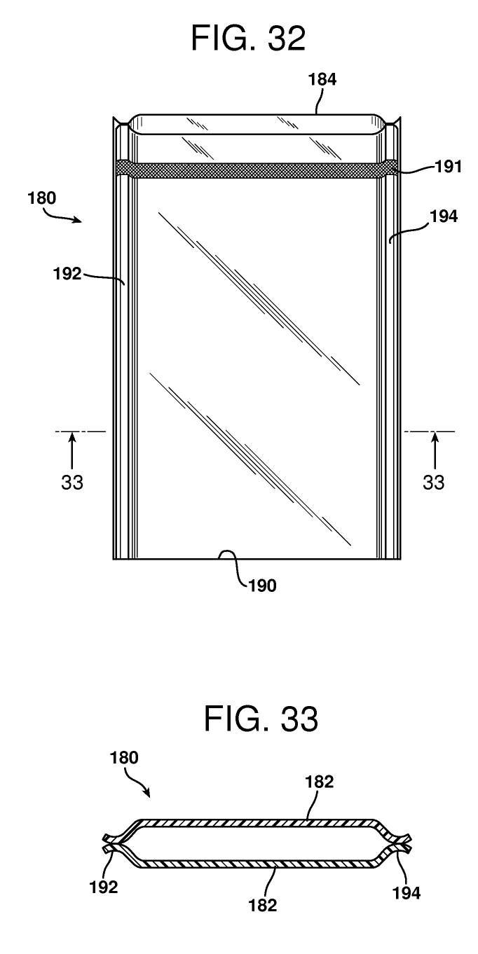

In one embodiment, and referring to FIGS. 32 and 35, the package of the invention can be made using otherwise conventional bag making equipment and processes. Bags are often made as side seal bags. The side seal bag has a factory-made heat seal at opposite bag edges. The bag bottom is formed by one of two folds of film created during the extrusion of bag tubing during manufacture. The opposite fold of film is slit to form a bag mouth. The bag is typically made from a long length of bag tubing. A method of making side seal bags is disclosed in US 2008/0138478 A1 (Ebner et al.), this patent incorporated herein by reference in its entirety.

FIGS. 32 and 33 illustrate bag 180. FIG. 32 illustrates a side seal bag 180, in a lay-flat view; FIG. 33 illustrates a cross-sectional view taken through section 15-15 of FIG. 32. With reference to FIGS. 32 and 33 together, side seal bag 180 comprises a web 182, first edge 184 defining an open mouth, edge fold 190, first side seal 192, and second side seal 194. Discrete strip is installed on the individual bag, or on a bag tube that is then cut and sealed at predetermined intervals to make a series of side seal bags 180, by any suitable process such as any of those disclosed herein.

A bag with a die cut and discrete strip disposed thereon can be made by extruding a thermoplastic tube to make a bag tubing; die cutting the bag tubing at predetermined intervals; slitting the tubing at one longitudinal edge thereof; and periodically transversely cutting and sealing the bag tubing to make a plurality of individual bags each with a discrete strip disposed thereon. The discrete strip and die cut can function as described herein for other embodiments and processes, in providing an easy-open and reclosable package. Some of the steps set out in US 2008/0138478 A1, for making a bag, are optional with respect to the present invention; such steps including irradiation and orientation of the tubing.

During the method of making the bag, the first and second surfaces of the discrete strip are sealed to the slit bag tubing, or the inner surfaces of the first and second side panel respectively.

A package made from the bag will include a first surface of the strip sealed to an inner surface of a first side panel of the package, and a second surface of the strip sealed to an inner surface of a second side panel of the package with one or both of these seals being an easy-open seal.

Method of Operation

In opening the package of FIGS. 28A to 28C, die-cut segment 56 defined by a first closed-loop die cut 21 (see also FIGS. 29A and 29B) is manually grasped and completely removed from the first side panel 12. The first end of strip 10 is then grasped and pulled away from the second side panel 14, breaking through the easy-open seal that bonds second surface 25 of strip 10 to inner surface 29 of second side panel 14, to access product in the interior 57 of the package. During this opening sequence, the anchor in region “A” between surfaces 23 of the strip and 27 of first side panel 12 will typically remain intact, such that a portion of the strip 10 stays on and in contact with surface 27.

In an alternative arrangement (see FIGS. 29C and 29D), a die-cut segment is similar in profile to that defined by the first closed-loop die cut 21 of FIG. 30F, but open-looped with a flap hinge 58. Flap 26 (see FIG. 29C) is manually grasped and pulled up from the first side panel, and back toward the first end of the package along flap hinge 58. The end of strip 10 closest to flap 26 is then grasped and pulled away from the second side panel 14, breaking through the easy-open seal that bonds second surface 25 of strip 10 to inner surface 29 of second side panel 14 to access product in the interior 57 of the package. During this opening sequence, the anchor in region “A” between surfaces 23 and 27 of first side panel 12 will typically remain intact, such that a portion of the strip 10 stays on and in contact with surface 27. Optionally (see FIG. 30D), more than one die cut can be present. The first die cut is in some embodiments close-looped, i.e. the die cut defines a die-cut segment that can be displaced or completely removed from the first side panel of the package. The second die cut can also be close-looped (see e.g. FIG. 30D), or can be open-looped and hinged. Alternatively, a single die cut can be used, that is either close-looped or includes a hinge line. Each die cut can be of any suitable geometry and depth.

Method Of Making A Die Cut In A Web

A conventional die cutter can be used to create a first die cut 21, and optionally one or more additional die cuts 36 in a web that is used to make first side panel 12. Die cuts can be made by any suitable conventional process and equipment. Any suitable pattern of die cut can be used, open or close-looped, as long as it serves the function of providing an easy open package in which the packaged product can be accessed by means of a flap created at least in part by the die cut. Alternative patterns include elliptical, oval, triangular, three side rectangle, hour glass, “dog bone”, and other regular and irregular shapes.

The die cut extends completely through the first side panel, or may extend through most of, but not entirely through, the thickness of the panel. The die cut may extend through e.g. at least 50% of the thickness of the first side panel, e.g. at least 60%, at least 70%, at least 80%, at least 90%, at least 95%, or 100% of the thickness of the first side panel 12.

A laser system can be configured to produce a laser cut that cuts partly or completely through the panel, or alternatively, a die cut can be made using a mechanical cutting system using rotary engraved dies, or steel rule dies supported in platens as used in reciprocating presses. The choice of die cutting technique depends on several factors, including the thickness and physical nature of the film or web to be cut.

The die cut may act as a tamper evident feature.

The die cutting of a web to produce a the first side panel, and the assembling of a package incorporating a die cut web, can be done at a single location, but more practically will typically be done at separate locations, with the assembling of the package by a packager using a pre-provided strip and a die cut web prepared elsewhere and provided in advance of the packaging process.

The above descriptions are those of embodiments of the invention. All parts and percentages are by weight, unless otherwise indicated or well understood in the art. Except in the claims and the specific examples, or where otherwise expressly indicated, all numerical quantities in this description indicating amounts of material, reaction conditions, use conditions, molecular weights, and/or number of carbon atoms, and the like, are to be understood as modified by the word “about” in describing the broadest scope of the invention. Any reference to an item in the disclosure or to an element in the claim in the singular using the articles “a,” “an,” “the,” or “said” is not to be construed as limiting the item or element to the singular unless expressly so stated. All references to ASTM tests are to the most recent, currently approved, and published version of the ASTM test identified, as of the priority filing date of this application. Each such published ASTM test method is incorporated herein in its entirety by reference.

Terms referring to polymers, such as polyester, polyamide, and polyolefin, refer herein to both homopolymers and copolymers thereof, unless otherwise specified.

With reference to the drawings, the flow of materials is in the direction of the arrows.

Those of skill in the art will recognize that the drawings herein are not necessarily to scale, and certain features of the invention may be graphically exaggerated for clarity.

Both the web or webs used in the manufacture of the package according to the invention, and the discrete strip of the invention, can be made by any suitable process, including coextrusion, extrusion coating, extrusion lamination, and conventional lamination using polyurethane or other adhesives. These manufacturing processes are well known in the art. Extrusion can be done in annular or flat dies. The extrudate can be hot blown or cast, and optionally solid-state oriented as desired. Chemical or electronic crosslinking of one or more layers of the webs or the strip can be done. Both web and strip can be advanced by suitable motive means (not shown, and well known in the art, such as a motor) from their respective rolls.

A package according to the invention can optionally carry printed indicia, which can be decorative or informational in nature. Decorative printed indicia can include a logo, a trademark, product information, etc. with text and/or graphics.

Printed indicia can be in the form of a message e.g. “easy open” or “open here”. This can be printed in scattered process (i.e. registration is not required) on or near the first end of the package. The message is surface printed or reverse printed.

In some embodiments, such as those shown in FIGS. 8 to 14, it may be beneficial to adhere the discrete strip to the lay-flat web prior to processing on equipment, or at the time, before processing, when the strip is disposed on the web. Any suitable means, such as permanent adhesive or heat sealing, can be used to seal the strip to the web to ensure that the strip maintains its position on the web during processing. In these embodiments, the strip is anchored to the web at the interface between the web and the surface of the strip comprising a sealant layer that provides a relatively strong seal. The strip can be e.g. sealed to the web by a suitable device (not shown) such as a heat sealer, disposed below the web (see FIGS. 8 and 12) while the web is in its lay-flat condition, that seals the strip to the web. In such embodiments, the surface of the discrete strip that comprises the easy-open surface faces away from the web, so that the opposite surface of the discrete strip is sealed to the web. This approach leaves the easy-open surface unaffected until such time as the package is made and closed, or until e.g. the lap or fin seal is made on the pouch.

In the embodiments disclosed herein, the first end of the package can be sealed, typically where two webs are used to make the package. Alternatively, the first end of the package can be a fold, e.g. where a single web of material is used to make the package.

The present invention, including the package and methods as disclosed herein, is provided in several embodiments in the absence of: plastic zipper closures; press-to-close or slide zippers; interlocking closures; reclosable fasteners with interlockable fastener elements; interlocking rib and groove elements having male and female profiles; interlocking alternating hook-shaped closure members, and the like. None of these aforementioned closures, zippers, elements, etc. is present in the package of the invention.

Although the invention is described in some embodiments herein as a package comprising a thermoplastic pouch comprising a first and second side panel each having a top edge, a first side edge, and a second side edge, those skilled in the art will understand, after a review of this disclosure, that in some embodiments, wherein a single web is used, the terms “side panel”, “top edge”, “first side edge”, “second side edge”, and the like are used for convenience to describe the relative locations or regions on a single web made into a pouch, so that the overall geometry of the package, and relative positions of the various features of the invention can be described. Thus, for instance, the first and second panels in a single web embodiment of the invention can be simply defined regions of the pouch, and the package made therefrom, and side edges are simply the side end lines of those regions. In such embodiments, the line of joinder of the side edges are the two side folds in the web that define the sides of the package. In contrast, in embodiments with two webs, each web when produced will have an identifiable first and second side edge, that will each be joined to a respective side edge of a second web.

Although the first and second side panels are shown in various embodiments as having the same length, the second side panel can in some embodiments be longer than the first side panel, i.e. the first end of the second side panel can extend beyond the first end of the first side panel, or vice versa. The extended portion can e.g. accommodate a hang tab with a hole therein, or function as a fold-over flap for reclosing the package after opening.

In some embodiments, a seal can be applied obliquely across the two corners of the front panel of a package of the invention, closest to the first end of the package, such that it crosses over and seals two corners of the discrete strip to the front panel. These angled seals can be useful in facilitating the reclosure of the package after opening.

What is claimed is:

1. An easy-open package comprising:
a) a pouch comprising
i) a first and second side panel each comprising an outer and inner surface, a first and second side edge, and a first and second end, the first and second side panels joined together along their respective first and second side edges;
ii) a first end defined by the first end of at least one of the first and second side panels;
iii) a second end defined by the second ends of the first and second side panels respectively;
iv) the first and second side panels joined together along their respective second ends;
v) a discrete strip, disposed between the first and second side panels, comprising a first and second surface, wherein
(a) the first and second surface each comprises a sealant,
(b) at least one of the first and second surfaces of the discrete strip comprises an easy-open sealant,
(c) the first surface of the discrete strip is sealed to the inner surface of the first side panel,
(d) the second surface of the discrete strip is sealed to the inner surface of the second side panel, and
(e) the discrete strip is near and spaced apart from the first end of the pouch, and spaced apart from the second end of the pouch;
vi) a die cut disposed in the first side panel;
vii) the first end of the first side panel joined to the second side panel; and
b) a product disposed in the pouch.

2. The package of claim 1 wherein the first and second side panels are joined together along their respective first and second side edges with a seal.

3. The package of claim 1 wherein the first and second side panels are joined together along their respective first and second side edges with a fold.

4. The package of claim 1 wherein the first end of the first side panel, and the second side panel, are joined together with a seal.

5. The package of claim 1 wherein the first end of the first side panel, and the first end of the second side panel, are joined together with a seal.

6. The package of claim 1 wherein the first end of the first side panel, and the first end of the second side panel, are joined together with a fold.

7. The package of claim 1 wherein the second end of the first side panel, and the second end of the second side panel, are joined together with a seal.

8. The package of claim 1 wherein the second end of the first side panel, and the second end of the second side panel, are joined together with a fold.

9. The package of claim 1 wherein the discrete strip is disposed perpendicular to the first and second side edges of the first and second side panel respectively.

10. The package of claim 1 wherein the package is absent any zipper.

11. The package of claim 1 wherein the package is absent pressure sensitive adhesive.

12. The package of claim 1 wherein the package can be opened with a peel force of from 25 grams/inch to 5 pounds/inch.

13. A method of making an easy-open package in a horizontal form/fill/seal process comprising:
a) providing a lay-flat web comprising a die cut;
b) providing a discrete strip comprising a first and second surface each comprising a sealant, at least one of the first and second surfaces of the discrete strip comprising an easy-open sealant;
c) advancing the lay-flat web to a forming device to convert the lay-flat web to a folded web having an interior surface;
d) advancing the discrete strip such that when the package is made, the discrete strip is disposed between a first and second side panel of the package;
e) making side seals in the folded web to produce an open pouch comprising
i) the first and second side panels each comprising an outer and inner surface, first and second side edges, and a first and second end, the first and second side panels joined together along their respective first and second side edges by a seal,
ii) a first end defined by the first end of at least one of the first and second side panels,
iii) a second end defined by the second ends of the first and second side panels respectively,
iv) the first and second side panels joined together along their respective second ends,
v) the discrete strip spaced apart from the first and second end of the pouch,
vi) the die cut disposed in the first side panel
f) putting a product in the open pouch; and
g) sealing the first end of the first side panel to the second side panel;
at any time during the method of making the easy-open package, sealing the first surface of the discrete strip to the lay-flat web or folded web such that the first surface of the discrete strip is sealed to the inner surface of the first side panel, and sealing the second surface of the discrete strip to the lay-flat web or folded web such that the second surface of the discrete strip is sealed to the inner surface of the second side panel; and
during or after the step of making side seals in the folded web, cutting the web.

14. The method of claim 13 wherein the first end of the first side panel, and the first end of the second side panel, are joined together with a seal.

15. The method of claim 13 wherein the first end of the first side panel, and the first end of the second side panel, are joined together with a fold.

16. The method of claim 13 wherein the second end of the first side panel, and the second end of the second side panel, are joined together by a seal.

17. The method of claim 13 wherein the second end of the first side panel, and the second end of the second side panel, are joined together by a fold.

18. The method of claim 13 wherein the package is absent any zipper.

19. The method of claim 13 wherein the package is absent pressure sensitive adhesive.

20. The method of claim 13 wherein the package can be opened with a peel force of from 25 grams/inch to 5 pounds/inch.
